(19) United States
(12) Patent Application Publication
(10) Pub. No.: US 2013/0007186 A1
(43) Pub. Date: Jan. 3, 2013

(54) CONTROLLING CONTENT CACHING AND RETRIEVAL

(75) Inventors: Hang Liu, (US); Xavier De Foy, Kirkland (CA); Osama Lotfallah, King of Prussia, PA (US); Serhad Doken, Chester Springs, PA (US); Milan Patel, Harrow (GB); Kamel M. Shaheen, King of Prussia, PA (US)

(73) Assignee: INTERDIGITAL PATENT HOLDINGS, INC., Wilmington, DE (US)

(21) Appl. No.: 13/536,491

(22) Filed: Jun. 28, 2012

Related U.S. Application Data
(60) Provisional application No. 61/503,225, filed on Jun. 30, 2011.

(51) Int. Cl. G06F 15/167

(52) U.S. Cl. 709/213

(57) ABSTRACT

A tracker application server (AS) instructs a content cache server (CCS) to join a peer-to-peer (P2P) swarm based on the status of the P2P swarm. The tracker AS determines whether to invite a CCS to join the P2P swarm be based on an underlying network condition change, a peer node joining or leaving the P2P swarm, change(s) in traffic condition, location, capability or workload of the peer node(s) in the swarm. The tracker AS sends an invitation message to the CCS, indicating the content of interest and a peer list identifying the peer nodes of the P2P swarm. Upon receiving the invitation message from the tracker AS, the CCS sends a response to the tracker AS. Upon receiving a response indicating the acceptance of the invitation, the tracker AS puts the CCS into the P2P swarm, and the CCS joins the swarm using a P2P protocol.

### CROSS-REFERENCE TO RELATED APPLICATIONS

This application claims the benefit of U.S. Provisional Application No. 61/503,225, filed Jun. 30, 2011, which is hereby incorporated by reference herein.

### BACKGROUND

Distribution and retrieval of multimedia content has become a leading use of the Internet and mobile networks. Content delivery networks (CDN) may be used to shorten users' startup delay, improve quality of experience, and reduce the transit traffic within the networks improve quality of experience. For example, edge servers may be strategically located at the edge of the Internet to form an overlay network. In a particular CDN, caching may be performed based on the business model of the provider of the CDN, and may include acquiring and serving certain managed contents.

An IP multimedia system (IMS) may provide a platform to establish standard services for wireless and IP networks. However, current IMS architecture may not always efficiently route an IMS-based content request to a cache node in CDN overlays. For example, in an IMS system, user equipment (UE) may send a request for streaming a video content. The IMS system may forward the request to a content server even if a copy of the requested video content is available at a cache node in the local mobile network.

### SUMMARY

Methods, systems, and apparatus for managing content caching, retrieval and distribution. In an embodiment, a tracker application server (AS) may instruct a content cache server (CCS) to join a peer-to-peer (P2P) swarm. A CCS may be deployed by the network, network operators, and/or service providers for improving distribution and retrieval of content or content objects. The tracker AS may determine whether to invite a CCS to join the P2P swarm based on the status of the swarm. For example, the determination may be based on an underlying network condition change, a peer node joining or leaving the P2P swarm, change(s) in traffic condition, location, capability or workload of the peer node(s) in the swarm. Upon a determination to invite, the tracker AS may send an invitation message to a CCS requesting the CCS to join the P2P swarm. The invitation message may include an indication of the content of interest and/or a peer list identifying the peer nodes of the P2P swarm. The tracker AS may instruct the CCS to retrieve the corresponding content/content segments if the content of interest is not cached at the CCS. For example, the invitation message may include content retrieval instruction, such as the instruction to retrieve the content/content segments from a content source server, peer nodes and/or other CCS(es) in the P2P swarm.

The CCS may receive the invitation message from the tracker AS requesting the CCS to join the P2P swarm. The CCS may determine whether to join the P2P swarm, for example, based on workload, available storage, content requested, a characteristic of the P2P swarm, a characteristic of the tracker AS and/or usage policy or the like. The CCS may send a response to the invite message. For example, based on a determination to join the swarm, the response may include an indication of accepting the invitation/request to join the P2P swarm. Based on a determination to not join the swarm, the response may include an indication of declining the invitation/request. Upon receiving a response from the CCS with indication of accepting the invitation join the P2P swarm, the tracker AS may put the CCS into the swarm. For example, the tracker AS may update the peer list by adding the CCS to the peer list associated with the swarm.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an example radio access network and an example core network that may be used within the communications system illustrated in FIG. 1A.

FIG. 1E is a system diagram of an example radio access network and an example core network that may be used within the communications system illustrated in FIG. 1A.

FIG. 2A illustrates an example cache-aware IMS architecture.

FIG. 2B is a diagram illustrating an arrangement of storage resource functions (SRFs) of FIG. 2A.

FIG. 3 is a signaling diagram illustrating a signaling operation between a storage resource broker (SRB) and a SRF.

FIG. 4 is a signaling diagram illustrating another signaling operation between the SRB and the SRF.

FIG. 5 is a signaling diagram illustrating a further signaling operation between the SRB and the SRF using an adapter.

FIG. 6 is a signaling diagram illustrating yet another signaling operation between the SRB and the SRF using an adapter.

FIG. 7 is a signaling diagram illustrating a signaling operation for establishing a content distribution or streaming session.

FIG. 8 is a signaling diagram illustrating another signaling operation for establishing a content distribution or streaming session.

FIG. 9 is a signaling diagram illustrating a further signaling operation for establishing a content distribution or streaming session.

FIG. 10 is a diagram illustrating a method for a SRF to join a peer-to-peer (P2P) swarm for stored content retrieval.

FIG. 11 illustrates a P2P content distribution system having a SRF serving as a network peer.

FIG. 12 illustrates example signaling for a SRF to serve as a network peer in a P2P swarm.

FIG. 13A illustrates example P2P content distribution system having a content cache server (CCS) serving as a network peer.

FIG. 13B illustrates example signaling for a CCS joining a P2P swarm.

FIG. 14 illustrates example signaling for a CCS joining a P2P swarm.

FIG. 15A illustrates example procedure for adding a content cache server to a P2P swarm.

FIG. 15B illustrates example procedure for a content cache server to join a P2P swarm.

### DETAILED DESCRIPTION

System embodiments and method embodiments for single frequency dual cell mobility are disclosed herein. The following sections provide a description of these various embodiments.

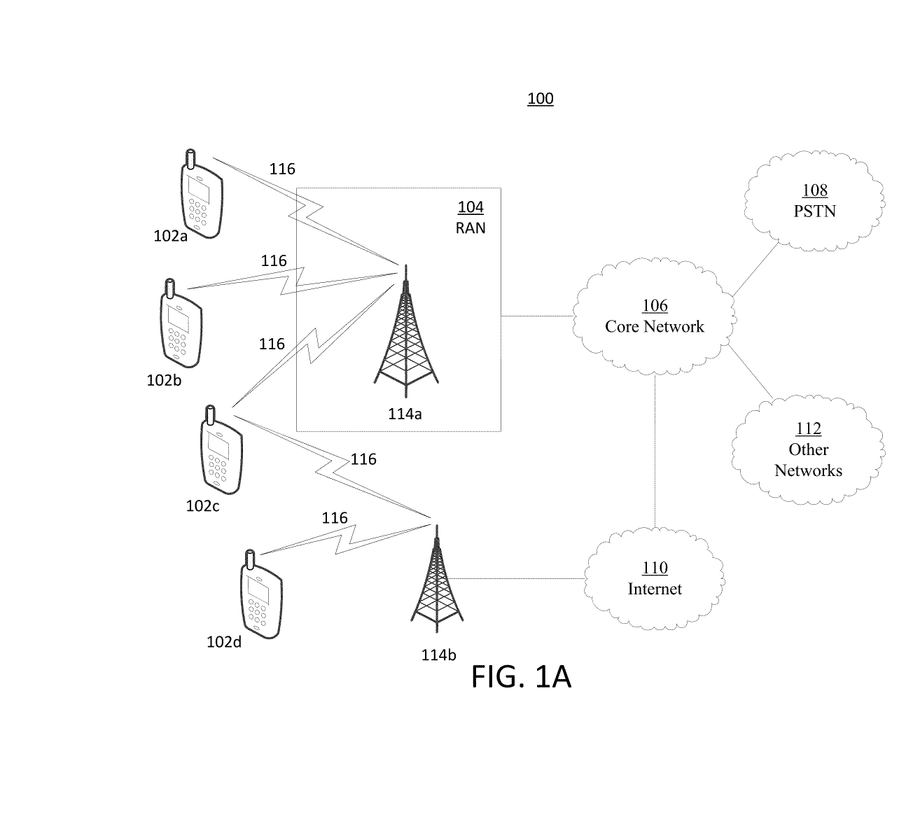

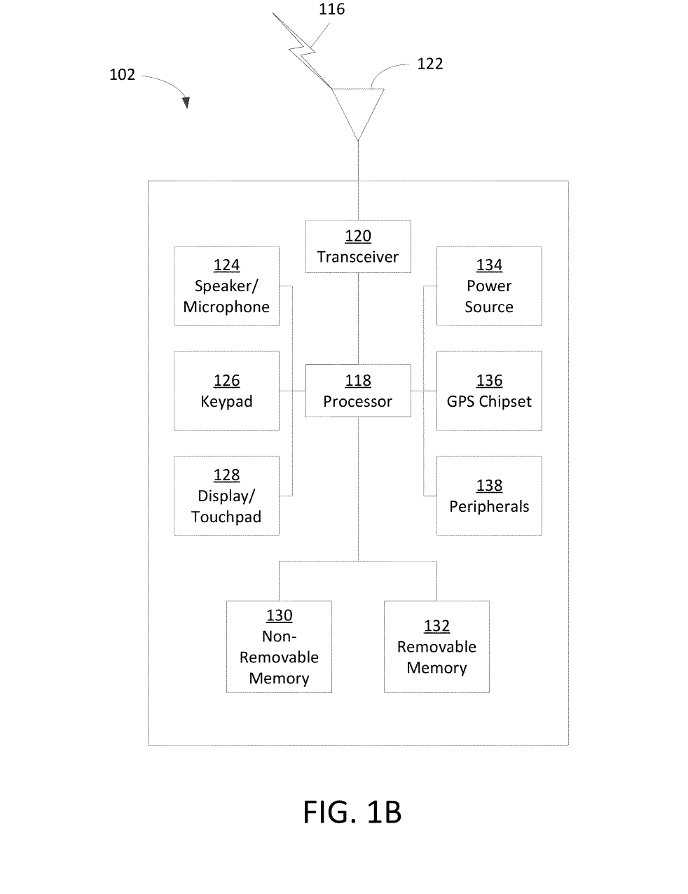

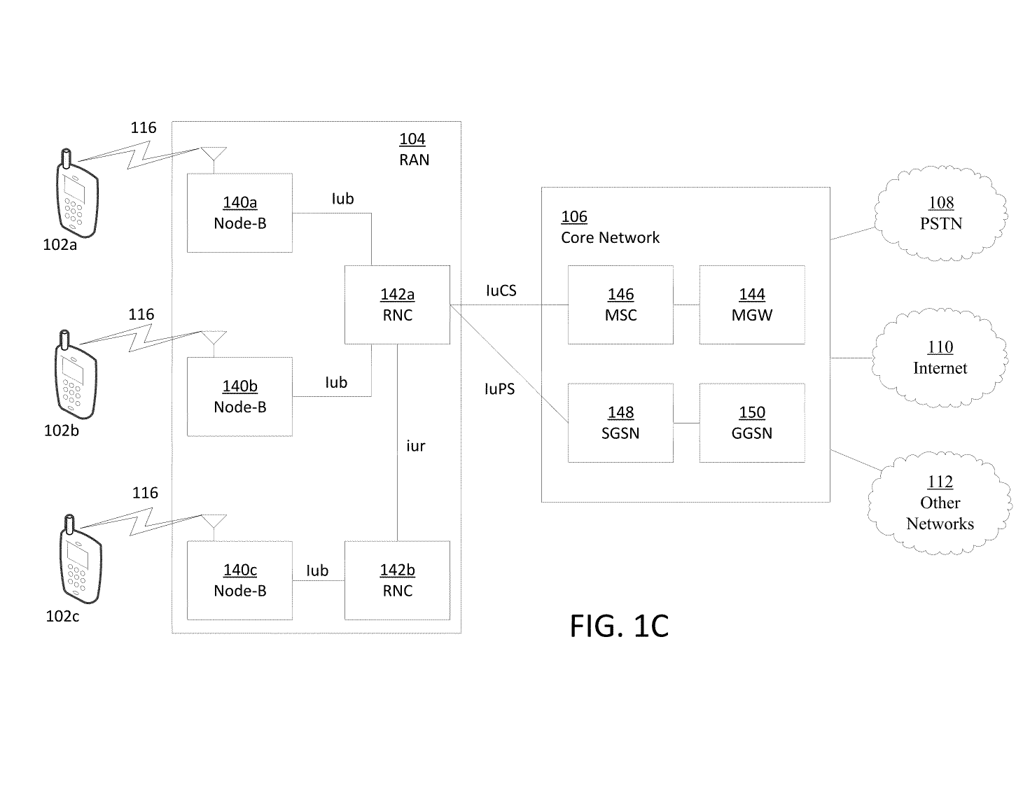

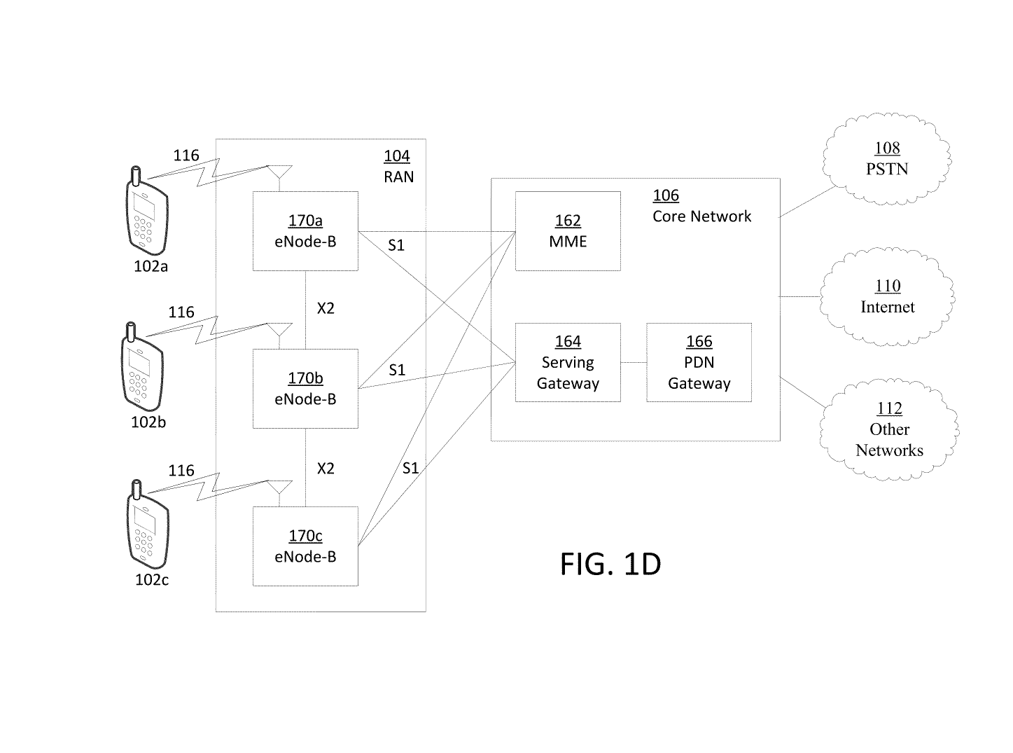

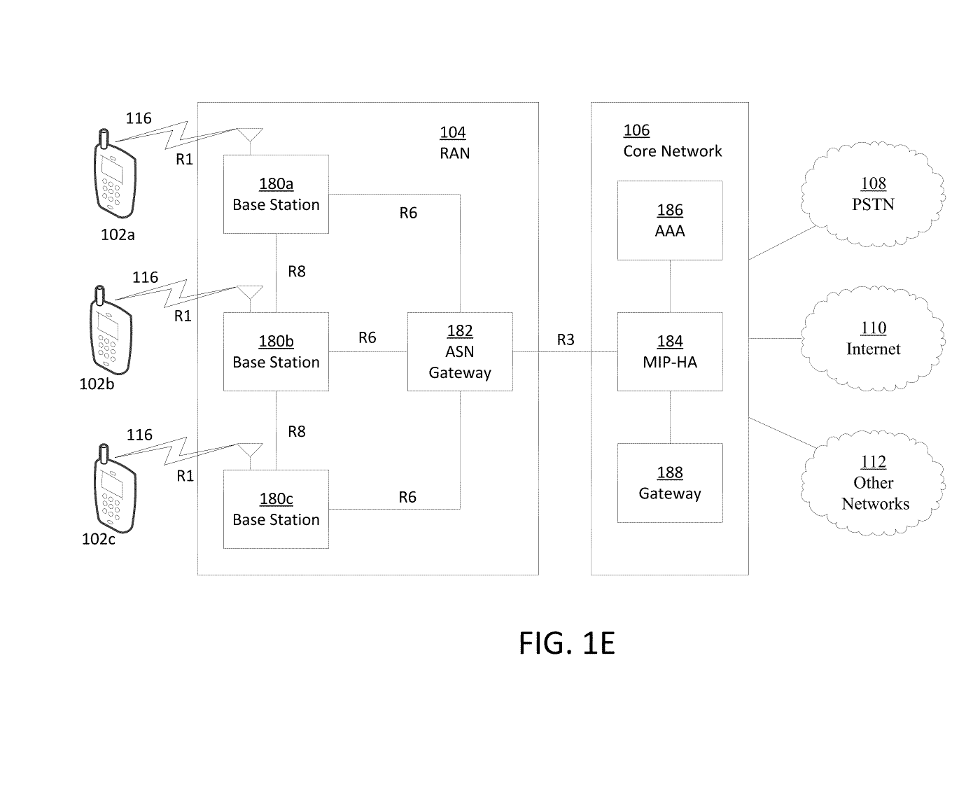

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode-B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The core network 106 may include at least one transceiver and at least one processor. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b and 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 170a, 170b, 170c, though it will be appreciated that the RAN 104 may include any number of eNode-Bs while remaining consistent with an embodiment. The eNode-Bs 170a, 170b, 170c may each include one or more transceivers for communicating with the WTRUs 102a, 102b, 102c over the air interface 116. In an embodiment, the eNode-Bs 170a, 170b, 170c may implement MIMO technology. Thus, the eNode-B 140a, for example, may use multiple antennas to transmit wireless signals to, and receive wireless signals from, the WTRU 102a.

Each of the eNode-Bs 170a, 170b, 170c may be associated with a particular cell (not shown) and may be configured to handle radio resource management decisions, handover decisions, scheduling of users in the uplink and/or downlink, and the like. As shown in FIG. 1D, the eNode-Bs 170a, 170b, 170c may communicate with one another over an X2 interface.

The core network (CN) 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 170a, 170b, 170c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 170a, 170b, 170c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 180a, 180b, 180c, and an ASN gateway 182, though it will be appreciated that the RAN 104 may include any number of base stations and ASN gateways while remaining consistent with an embodiment. The base stations 180a, 180b, 180c may each be associated with a particular cell (not shown) in the RAN 104 and may each include one or more transceivers for communicating with the WTRUs 102a, 102b, 102c over the air interface 116. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 215 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 184, an authentication, authorization, accounting (AAA) server 186, and a gateway 188. While each of the foregoing elements are depicted as part of the core network 106, it will be appreciated that any one of these elements may be owned and/or operated by an entity other than the core network operator.

Caching, including in-network caching within mobile networks and Internet service provider (ISP) networks may improve the quality of user experience and save the bandwidth resources. Caching may improve delay and throughput performance by placing the content closer to the users. In-network caching may reduce cross-domain and cross-ISP traffic and lower the network service provider's expense. Mobile service providers and ISPs with in-network caching capability may provide caching services to content providers. A cache-centric network may improve distribution and retrieval of content or content objects. With advances of storage and microprocessor technologies, network elements from routers, base stations, gateways to mobile devices may be equipped with storage capacity and processing power at a low cost. These network elements may perform in-network caching or opportunistic caching to improve performance and reduce bandwidth usage.

For example, a copy of the content requested by a WTRU may be cached in the local mobile network. The copy of the content may be cached in a node closer to the WTRU or a node that may have a better network path to the WTRU than an origin content server. The local copy may be seamlessly provided to the WTRU.

Web proxy caching may be used to reduce delays, reduce bandwidth usage, and balance the traffic load. Web cache proxies can be installed in the ISP networks hierarchically or at the ends of high latency links. A web cache proxy may store copies of content passing through the proxy. Subsequent requests for the stored content may be intercepted by the cache proxy en route to the source server, and the requests may be served from the cache proxy. A cache manager may analyze Hypertext Transfer Protocol (HTTP) requests passing through the cache manager, and may redirect the requests to a cache server.

Content-oriented networking may accommodate content distribution and retrieval applications efficiently. For example, content ID-based routing may be implemented in IP networks. Content or a content object may be associated with a unique name or content ID, and content data may be retrieved in the network using the associated name or content ID. By decoupling the content identities (e.g., content identifiers) from their hosts or locations at the network layer, content caching and delivery may be performed from optimized cache locations. Content ID-based routing may allow gradual deployment of content cache routers in the networks.

Exemplary embodiments may be directed to methods, devices, and systems for controlling content caching and retrieval using a control plane (e.g., a separate control plane). A horizontal control plane may be provided in IMS architecture to support content-oriented networking. The horizontal control layer may be separate from the application plane and the data plane. A separate horizontal control plane in the IMS may enable content-oriented networking to achieve the same scalability, security, and performance as a clean-slate architecture may. With a separate control plane, caching control may be handled independently of the transport protocols used in the media content data plane. Data plane protocols may include HTTP, Real-time Transport Protocol (RTP), or the like. For example, with a separate control plane, a multicast content object transported by RTP can be cached and later retrieved from the cache with HTTP unicast. The common control layer in the IMS architecture may provide a foundation for using advanced cache placement and displacement algorithms. The network service providers may use the IMS as an integrated framework for cache control, content download, and/or streaming session control.

The separate control plane may be implemented in the IP Multimedia Subsystem (IMS) architecture, for example, by enhancing Session Initiation Protocol (SIP), enhancing service control functions (SCFs), and/or establishing service resource brokers (SRBs), among others. By making the IMS “cache-aware”, the IMS may take advantage of in-network caching and may enable scalable and efficient mechanisms in initiating and controlling multimedia sessions. The IMS control plane may route an IMS-based content request to a cache node.

For example, the IMS system may automatically cache popular content to appropriate locations and may retrieve the content from a suitable cache node or nodes that can improve the quality experience of user services, optimize system bandwidth, and/or save costs. The suitable cache node(s) may be selected based on predefined or determined criteria such as time delay, hop distance, and/or cost, among others. Network operators (NOs), mobile service providers (MSPs) and/or ISPs may determine the content to be cached based on, for example, the local use of the content. The IMS architecture may know content download and streaming request information for the network.

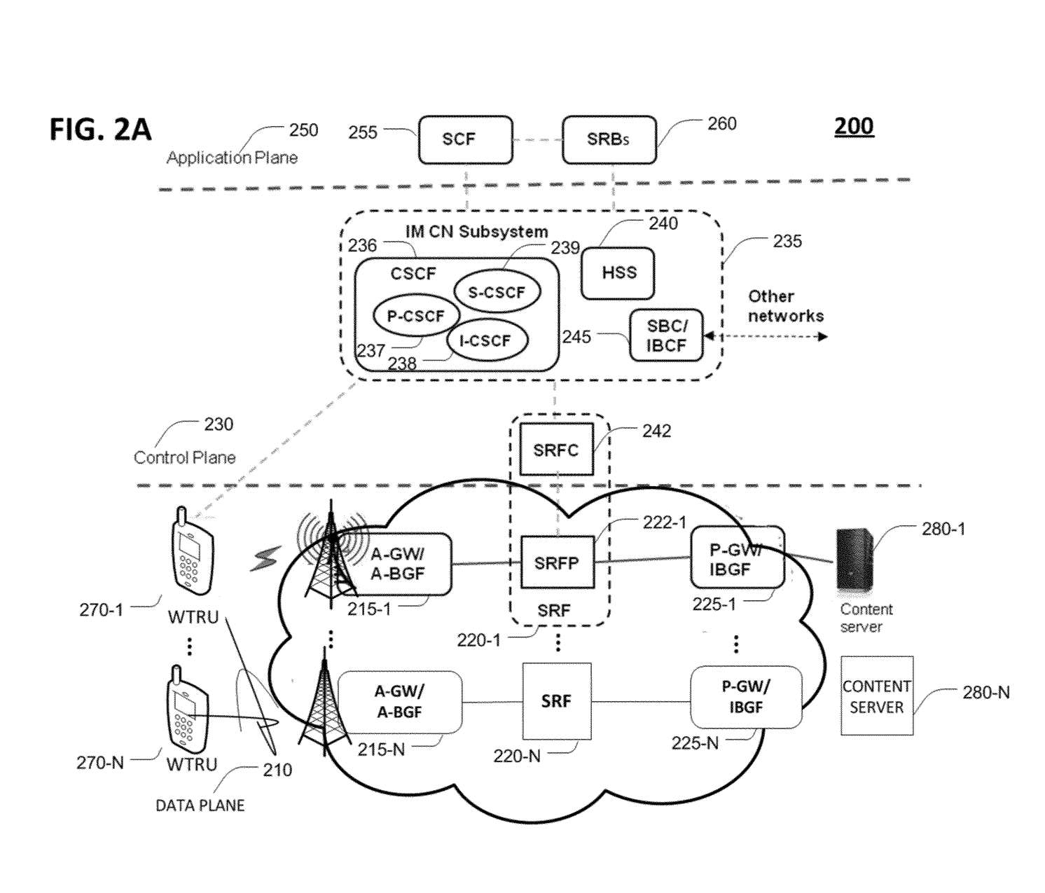

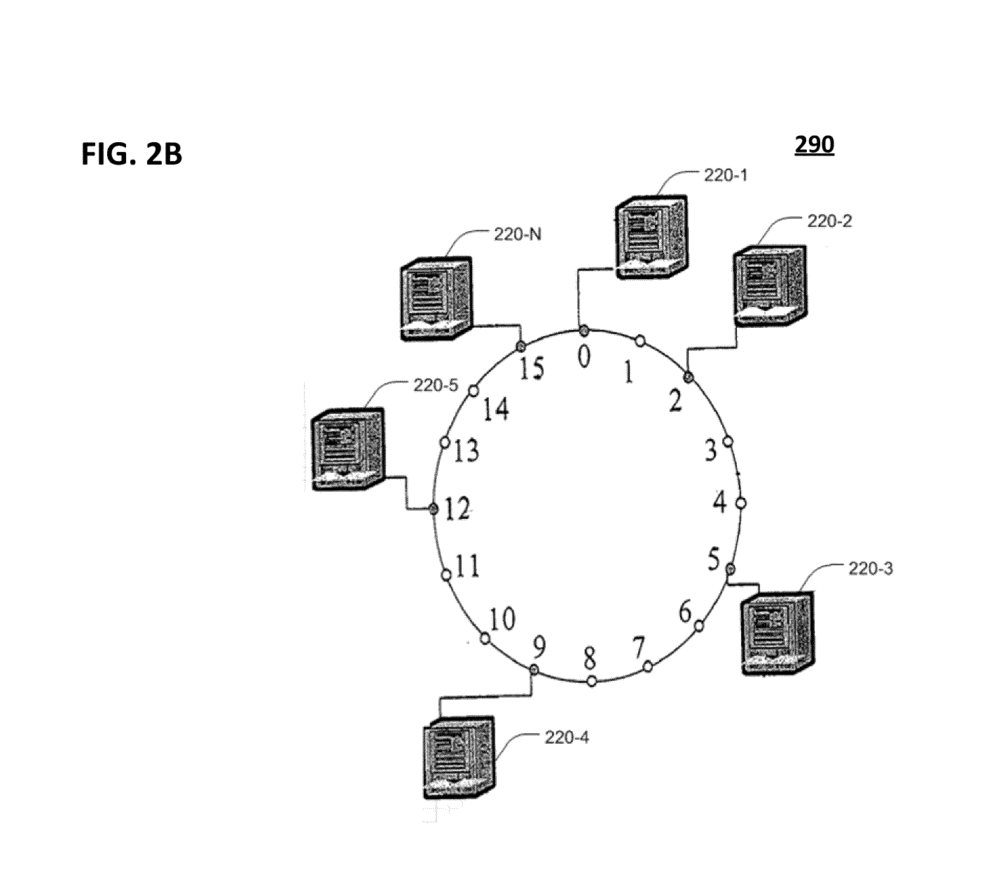

FIG. 2A illustrates an example IMS architecture having a separate control plane. The IMS architecture may provide a framework for delivering IP multimedia services. The IMS architecture may enable end users to access a wide range of services and applications via a common control plane regardless of network access technology. Session Initiation Protocol (SIP) may be used to initiate and control multimedia sessions, including establishment, modification, and termination of content retrieval, multimedia streaming or packet switch streaming (PSS), as well as broadcast and multicast streaming and download services.

As shown in FIG. 2A, an cache-aware IMS architecture 200 may include a control plane 230, a data plane (e.g., media plane) 210 and/or the application plane 250. The control plane 230 may be physically or logically separate from the data plane 210 and/or the application plane 250. The control plane 230 may communicate with the data plane elements and the application plane elements using, for example, SIP messaging (e.g., signaling).

The data plane 210 may include, an access gateway/access border gateway function (A-GW/A-BGF) 215, a Storage Resource Function (SRF) 220 (e.g., a serving gateway (S-GW)) and/or a PDN gateway/interconnect border gateway function (P-GW/IBGF) 225. The A-GW/A-BGF 215 may include an access gateway (A-GW) and/or an access border gateway function (A-BGF). The P-GW/IBGF 225 may include a packet data network gateway (P-GW) and/or an interconnect border gateway function (IBGF).

For the data plane 210, the elements in radio access networks (RANs) and CNs, e.g. eNode-Bs, A-GW/A-BGF 215, the serving gateway (S-GW), the P-GW/IBGF 225 may provide connectivity and media content data transport between WTRU 270 and the content server 280. The A-BGF 215 may enforce policy on the access media path. The content server 280 (e.g., original content server) may be located a network or the Internet external to the operator, mobile service or ISP network.

The control plane 230 may control content caching and content retrieval. In an embodiment, the control plane 230 may include an IMS core network (IM CN) subsystem 235 and a SRF controller (SRFC) 242. The SRFC 242 may communicate with the SRF 220 in the data plane 210 and the IM CN subsystem 235 in the control plane 230.

The IM CN subsystem 235 may include, but not limited to, a call session control function (CSCF) 236 that may include a proxy-CSCF (P-CSCF) 237, an interrogating-CSCF (I-CSCF) 238 and/or a serving-CSCF (S-CSCF) 239, a home subscribe server (HSS) 240 and/or an access gateway control function. The HSS 240 may include a session border controller/an interconnect border controller function (SBC/IBCF) 245. The access gateway control function may send control signals/messages to and receive control signals/messages from other networks. A user agent (UA) (not shown), located in the WTRU 270 may interact with the control plane elements (e.g., the IM CN Subsystem 235) to perform content service initiation, modification and/or termination.

In an embodiment, SIP may be used as a protocol for caching, distribution and/or retrieval of content with the IMS architecture 200. SIP messages may carry caching and storage event information.

The application plane 250 may include one or more service control function (SCF) 255 and one or more service resource broker (SRB) 260. The SCF 255 and the SRB 260 may interact (e.g., communicate) with the IM CN subsystem 235. The IM CN subsystem 235 may support user registration and authentication, mobility and roaming, control of multimedia sessions, QoS control, policy control and/or charging, among others. Application servers (not shown) may host and execute the SCF 255 and the SRB 260, and interface with the S-CSCF 239 using SIP. The SRB 260 may include a database or table, for example, to look-up or query stored content identifiers and provide associated SRF 220 content identifiers. The SRB 260 may maintain the information regarding to the cached content location and storage availability in its local directory. The SRB 260 may use a domain name system (DNS) for the content location information.

In an embodiment, the application plane 250 may include one or more peer-to-peer (P2P) tracker application server (tracker AS) (not shown). The data plane 210 may include one or more content cache server (CCS) (not shown). The tracker AS may collect CCS information such as available storage, cached content, and may supply CCS information to content consuming entities such as peer nodes in a P2P swarm. The tracker AS may be configured to perform functions of a SRB 260 described herein. In an embodiment, a tracker AS may include a SRB 260. The CCS may include the SRFC 242 and/or a SRF provider (SRFP) 222, which are described herein with respect to FIG. 2A.

The SRF 220 (and/or cache resource function) may provide content caching and content distribution (e.g., delivery and/or download) functions. The SRF 220 may include a device with storage (e.g., non-transitory storage) capability, including, but not limited to memory, flash memory, and/or optical or magnetic disk. A SRF 220 may include the SRFC 242 and/or a SRF provider (SRFP) 222. The SRFC 242 may include an element of the control plane 230. The SRFC 242 may interact (e.g., communicate) with the SRFP 222 of the SRF 220. The SRFC 242 may interact (e.g., communicate) with the SCF 255 of the application plane 250 and may interpret information from the SCF 255, another application server (AS), and/or CSCF 236 to control the SRFP 222 and/or to publish or register cached content. The SRFP 222 may include a data and/or media content plane element that may be used to obtain and to cache content. The SRFP 222 may serve the WTRU 270 for streaming, delivering, and/or distributing the content to the WTRU 270. The SRFP 222 may manage access rights to access the content. Multiple SRFs 220 may be deployed in the radio access networks or core networks. A SRF 220 may be integrated or co-located with a Node-B or an eNode-B 140, an access point, a base station 180, an A-GW 215, an A-BGF 215, an S-GW 164, a P-GW 166, an IBGF 225, a router, and/or a separate element within RANs and/or the CN 106, or the like.

The SRB 260 may collect SRF information such as available storage, cached content, and may supply SRF information to content consuming entities such as the SCF 255. The SRB 260 and SCF 255 may be implemented as an application server (AS) in an IMS network. One or more SRBs 260 may be deployed in the system.

The IMS system may include a plurality of SIP servers and SIP proxies configured to process the SIP signaling packets in the architecture 200. The P-CSCF 237 of the IM CN subsystem 235 may include a SIP proxy server that may be the first point of contact for the WTRU 270 inside a local or visited network. In an embodiment, the SBC 245 of the access gateway control function or other devices may provide or have integrated the P-CSCF 237 function. The P-CSCF 237 may be assigned to the WTRU 270-1 and may inspect signals from the WTRU 270.

The P-CSCF 237 may provide subscriber authentication, may establish a security association with the WTRU 270 and may ensure the signaling satisfies established polices. The P-CSCF 237 may compress and decompress SIP messages. For example, the P-CSCF 237 may forward SIP REGISTER requests from the WTRU 270 to the home network, forward other SIP messages from the WTRU 270 to another SIP server (e.g., a S-CSCF in the WTRU's home network), forward SIP messages from the network to another WTRU, perform modifications to SIP requests prior to forwarding, and/or maintain security associations with the WTRU 270.

The I-CSCF 238 may provide another SIP function and may be located at the edge of an administrative domain. The IP address of the I-CSCF 238 may be published in the Domain Name System (DNS). The IP address may be used as a forwarding address for SIP packets from a different network or different domain. The I-CSCF 238 may be the contact point within an operator's network for connections destined to a user of the network operator (NO) and for a roaming user located within the NO's operational area. The I-CSCF 238 may query the HSS 240, for example, to retrieve the address and capabilities of the S-CSCF 239 and may assign the retrieved address to the WTRU 270 that may perform SIP registration. The I-CSCF 238 may route or forward SIP requests and/or responses received from another network to the assigned S-CSCF 239.

In an embodiment, the S-CSCF 239 may include a central node of the control plane 230. The S-CSCF 239 may include a SIP server for performing session control including maintaining session state of the WTRU 270. The S-CSCF 239 may be located in the home network and may interface with the HSS 240, for example, to retrieve authorization. The S-CSCF 239 may handle SIP registrations and may manage registration and location information available to location servers. The S-CSCF 239 may be provided on the path of signaling messages (e.g., all signaling messages) of the locally registered users. The S-CSCF 239 may inspect the signaling messages and may determine to which application server or servers the SIP message may be forwarded to provide appropriate services.

The HSS 240 may include a database for WTRU 270 of users' subscription information and may provide user location information.

Although a P-CSCF 237, an I-CSCF 238, and an S-CSCF 239 are shown, it is contemplated that any number of these CSCFs may be used, for example, to provide for load distribution. The HSS may assign a particular S-CSCF 239 to a user, when the S-CSCF 239 is queried by the I-CSCF 238.

Users of IMS architecture 200 may be allocated at least one Public User Identifier (IMPU) of the address type SIP uniform resource identifier (URI), when they become IMS users. The IMPU may include an identity name part and a domain name part. The domain name part may include a domain name of the operator managing the user, (e.g., ID1@op2.com or ID2@op5.com). The identities may include E164 numbers associated with telephony identifications in combination with domain name(s). The identities may include aliases. The identities may be created based on the preference of the user(s). For example, the identity of a user may include a name that the user may desire to be published and made known as their IMS identity.

When a first user desires to establish a session with a second user, the target address (or an alias) may be placed in a “To” field of the SIP invite signal. The IMPU may be populated in the “Request URI” field. The IMPU may be used in the SIP routing algorithms, for example, between the originating S-CSCF 239 and the terminating I-CSCF 238.

The originating users identity may be entered into the “From” field of the invite to provide a routable return address, and possibly may be a presentable identity of the calling party to the called party.

In an embodiment, the P-CSCF 237 may forward an ID associated with the originating party, such as the caller ID, to the S-CSCF 239 of the originating party's local network (e.g., home network). The local network may forward the calling ID as a query to the HSS 240. The HSS 240 may retrieve from the database one or more communication identifiers (e.g., SIP URIs, Tel URIs, email addresses, and/or instant messaging addresses) and may submit the identifiers to the inquiring S-CSCF 239. The S-CSCF 239 may use the identifiers for reaching the originating party.

When a SIP or Tel URI is selected, the S-CSCF 239 may query the DNS server of the originating party's network for an IP address for communicating with an I-CSCF 238 of the originating party's network. The I-CSCF 238 may send a communication invite to the S-CSCF 239 of the originating party's network that may prompt a P-CSCF 237 of the originating party's network to pass the invite to the originating party's WTRU to establish communication. If the destination party's WTRU is not available for communication or the destination party cannot be reached, the S-CSCF 239 of the originating party's network may be configured to attempt communication on the next available communication identifier. The process may be repeated until the destination party is reached.

The SRF 220 may operate in multiple operational modes. For example, the SRF 220 may operate in an unmanaged and/or proactive operational mode. In the unmanaged mode, the SRF 220 may proactively cache content passing through the SRF 220. The SRF 220 may publish and/or register the cached content with the SRB 260 or an application server using (or via) the IM CN subsystem 235. Subsequent requests (e.g., IMS requests) for the same content may be served from the SRF 220 that cached the requested content. For example, the SRF 220 may operate in a managed and/or on-demand operational mode. In the managed mode, the SRF 220 may perform content ingestion, caching and/or content delivery at the request of the SCF 255 and/or the application server.

In the managed mode, whether to cache a content object or item may be determined The decision to cache and/or ingest a content object may be based on user demand for the content, network operator's need, and/or business relationship such as CDN. For example, the decision may be based on whether the content provider(s) may be willing pay for improved delivery of its content.

For example, the popularity of a content object may be determined The SCF 255 may determine whether to cache the content object based on the popularity of the content object. In an embodiment, if the content has been retrieved more than a threshold number of times, the SCF 255 may cache and/or ingest the content. In an embodiment, the SCF 255 may determine whether to cache the content object based on criteria such as the content being publicized or other information indicating a future demand for the content.

For example, the SCF 255 may determine whether to cache the content object base on the potential reduced bandwidth usage, reduced operator's cost and/or improved user's quality of experience as a result of caching the content object/item. The reduction of bandwidth may be based on the size of the content, and the improvement of the user experience may be based on whether the QoS, latency and/or other metrics associated with delivery of the content to the user meet or exceed a threshold.

The SRB 260 may operate in multiple operational modes. For example, the SRB 260 may operate in a query mode. In the query mode, the SCF 255 (or an application server) may query the SRB 260 for SRF information. The SCF 255 may set up (e.g., initiate, control and/or manage) the content delivery session using a response from the SRB 260. For example, the SRB 260 may operate in an in-line service mode. In the in-line service mode, the SCF 255 (or an application server) may send a message, such as a SIP INVITE message, to the SRB 260. In response to the message, the SRB 260 may establish, setup and/or initiate the content session at the SRF 220.

In an embodiment, the SCF 255 and/or the application server may communicate with the SRF 220 using the IM CN subsystem 235, or through an adapter (not shown) if the SRF 220 is not IMS-based.

In the IMS architecture 200, a network operator (NO) (e.g., a mobile network service provider or the ISP) may deploy and may control cache functions, servers and/or networks in its network domain. The NO may use the controlled cache functions to enable several efficient and scalable content delivery mechanisms. A cache function may include a content cache server, and the two terms may be used interchangeably herein.

The cache functions may be co-located with respective network elements in the NO's access network and/or the CN. The cache functions may cache or store the contents, for example, that may traverse the respective network elements. In an embodiment, the cache functions may be performed automatically. The cache functions may publish the cached contents through the control plane 230, for example, the IMS, the SRB(s), to other cache functions such as SRF 220-1 . . . 220-N and/or other network devices having memory, among other. Subsequent requests for the published content may be retrieved from the cache function that published the contents, or from other cache function caching the contents.

In an embodiment, multiple cache functions may be coordinated through the control plane 230, the SCF 255 and/or the SRB 260 (e.g., the IMS application server (AS)). For example, an access gateway A-GW 215-1 may include the SRF 220-1. The access gateway A-GW 215-1 may cache a content object passing through it and may publish the content object to the IMS (e.g., to the SRB 260). A WTRU 270-N coupled to, and/or registered with another access gateway such as A-GW 215-N may request the published content. The SCF 255 may look up the content ID associated with the content. For example, the SRB 260 may provide the SCF 255 with an identifier or address to locate a SRF 220 caching the content. Based on the content ID, the SCF 255 may route the request to the A-GW 215-1 through a backhaul link and may establish a path from the A-GW 215-1 via the A-GW 215-N to the requesting WTRU 270-N. The SRF 220 of the A-GW 215-1 may provide the requested content object (using the content ID provided in the request) via the established path to the WTRU 270-N. This may achieve improved cache utilization and system performance.

With a separate control plane, different data plane protocols may be selected and used. As an example, a SRF may cache a multicast TV content object that may be transported by RTP protocol. The cached content object may be retrieved from the SRF with unicast HTTP transport, and may be controlled by a separate control protocol. In another example, a SRF may download a content object using HTTP and may serve the client using RTP streaming or P2P protocol.

In an embodiment, the SRF 220-1, 220-2 . . . 220-N may publish (e.g., list) the contents in the SRB 260. A path to the appropriate SRF (e.g., SRF 220-1) may be established for retrieval of the contents. In an embodiment, the SRF 220-1 or WTRU 270-1 may store the contents at other cache functions based on predefined, user defined and/or NO defined cache policies. For example, after a predetermined number of requests for the content traversing a SRF (e.g., 220-1), the SRF 220-1 may cache or store the requested content for future requests. For example, after a predetermined number of requests for the content, the SRF 220-1 may deem the requested contents to be “popular” and may send the content to other cache functions such as the SRFs 220-2, 220-3 and/or 220-N.

In an embodiment, content cached on a cache function may be removed. For example, policies such as predefined, user defined and/or NO defined for removing the content from the cache function and/or un-publishing (or delisting the content) may be implemented. For example, the published content may be removed after observing no request for the content occurs for a threshold period and/or may be delisted from the SRB 260 after no request for the content occurs for the same or a different threshold period. In an embodiment, the content may be removed when the cache memory reaches a predetermined level of fullness and/or the priority of the published content is lower than a threshold priority. In an embodiment, when the cache memory reaches a predetermined level of fullness (e.g., when the memory is full, 95% full, or 90% full), the cached content of the lowest priority may be purged. The priority associated with a content object may be determined based on user defined criteria, content type, content length, content cache period, content request history, and/or retrieval time (e.g., content delivery latency) from the original cache source and/or an alternative cache source.

The policies may be set to reduce the incoming traffic from outside network domains to lower traffic load on its cross-domain links, lower costs for traffic peering and transport link capacity, improve the delay performance, and/or improve the throughput performance by placing the contents closer to the respective users.

The NO or the SCF 255 may instruct the SRB 260 to download and to cache content objects from origin servers through prepositioning or dynamic acquisition. The subsequent requests for the cached contents may be served from the SRFs 220-1 . . . 220-N (e.g., instead of the origin source). The NO may offer cache storage and delivery functionality to content providers. This may be advantageous to the content providers because the content providers may mitigate the capital expense associated with content servers and may improve the quality of user experience.

The SRFs may be used as a CDN. A SRF may automatically cache a content object and may publish/register the cached content object through IMS such that requests for the content object can be fulfilled from the SRF cached the object. In an embodiment, a SRF can be instructed to cache or acquire a content object by the SCF or AS without separate ingestion mechanism. The SCF can communicate with the SRF directly or through the SRB using the unified control plan protocol, IMS/SIP. The SRF can provide interface to proprietary content servers/networks.

FIG. 2B is a diagram illustrating an example arrangement of SRFs 220. Referring to FIGS. 2A and 2B, the SRFs 220 (e.g., SRFs 220-1, 220-2, 220-3, 220-4, 220-5 . . . 220-N) may communicate with each other over the control plane 230 or the SRFs 220-1, 220-2 . . . 220-N may coordinate and form a P2P network 290 (e.g., a chord P2P network) for in-network caching and content delivery. Although FIG. 2B shows a chord P2P network 290, it is contemplated that other network topologies are possible. For example, the P2P network 290 may include a Chord network, a CAN network, a mesh network, and/or a Pastry network, among others.

In an embodiment, the SRFs may act as network peers and may communicate with each other to collaboratively deliver a content object using a P2P (or overlay) network 290. A network peer may include a participant of a P2P network that may be deployed by the network, or network operators/service providers. A network peer may provide services to other participants of the P2P network such as user peers or network peers. A network peer may request services from other participants.

A content object may be distributed across a number of original content providers. An tracker application server (AS) may act as a tracker and may instruct a particular SRF 220 to join a P2P network 290 swarm. The tracker AS may instruct the particular SRF 220 to retrieve a content object and distribute the content via the media plane or P2P overlay network 290 to the requesting WTRU or another device.

Although content aware IMS architecture is shown in FIG. 2A, it is contemplated that embodiments are not limited to the use of the IMS architecture, but instead a different control protocol with different signaling messages may be implemented.

In an embodiment, a SRF 220 may be located in a network node or element including a base station, an eNode-B, a base station, an access point, a router, an access gateway, an S-GW, and/or a P-GW, among others. The SRF 220 may proactively cache the contents passing through it according to one or more policies. A content object may be published or registered to the SRB 260 after being cached by a SRF 220. The cached content object can be located when a WTRU or client requests a lookup in the SRB 260. The SRF 220 may publish or register the content or content object and the available storage space of the SRF 220 to the SRB 260, upon caching a new object. The SRF 220 may report events that may occur in its storage, including a new content object that may be cached, an existing content object that may be deleted, and/or an available storage space that may be changed, among others.

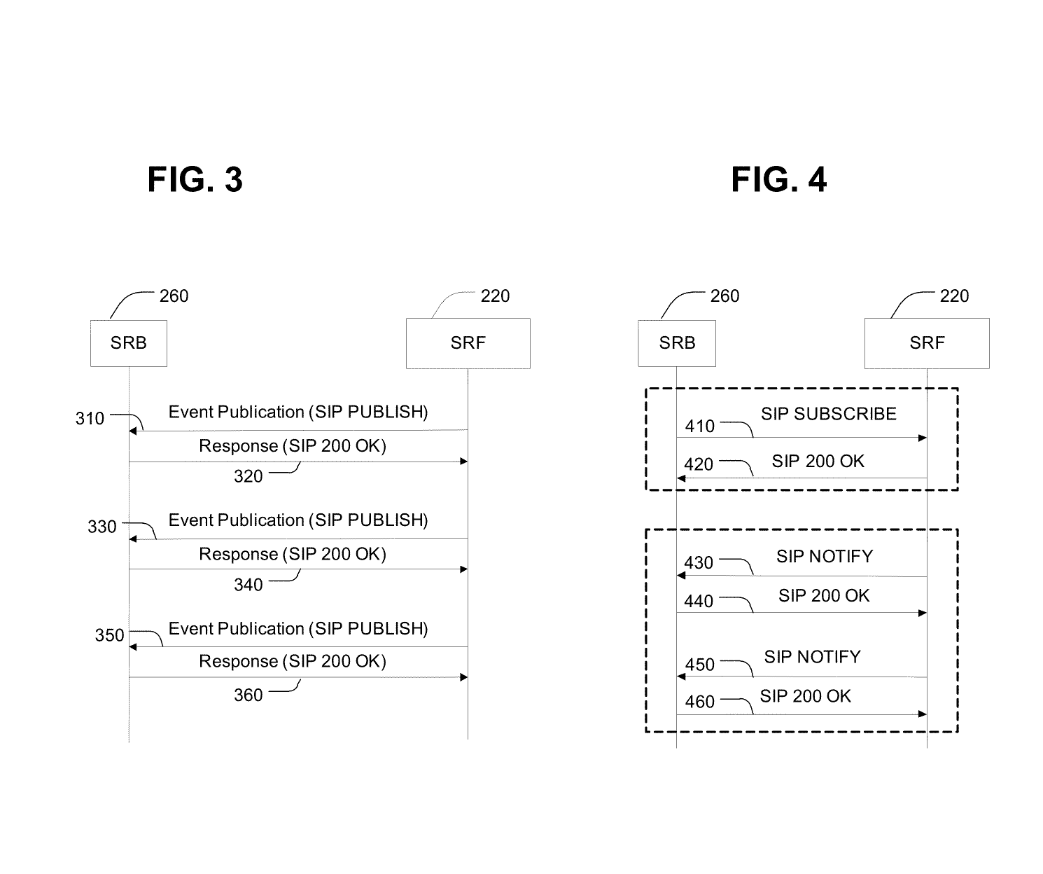

FIG. 3 illustrates an example signaling operation for caching content and publishing cached content. Referring to FIG. 3, contents traversing the SRF 220 (e.g. SRF 220-1) may be cached by the SRF 220. After caching the content, at 310, the SRF 220 may send a message (e.g., an event publication, a notification or a SIP PUBLISH message/signal) to the SRB 260 to inform the SRB 260 of the cache event. The SRB 260 may publish and/or list that the SRF 220 has a particular cache event concerning the content (e.g., a content object). A cache event may include new cache, remove cache and/or change cache space.

At 320, the SRB 260 may send to the SRF 220 a SIP 200 OK message, for example, in response to the reception of the SIP PUBLISH message. When other contents are cached by the SRF 220, the operations may be repeated to publish the cache of those contents. For example, at 330 and 350, the SRF 220 may send further SIP PUBLISH messages to the SRB 260 to inform the SRB 260 of cache events so that the SRB knows that the SRF 220 has cached respective contents (e.g., or content objects). At 340 and 360, the SRB 260 may respond to the reception of the further SIP PUBLISH messages/signals by sending to the SRF 220 respective SIP 200 OK messages.

In an embodiment, an IMS-based SRF 220 (e.g., SRF 220-1, 220-2 . . . 220-N) may publish storage events. For example, storage events such as new content objects being cached, existing content objects being deleted; and/or changes to available storage space in the IMS-based SRF 220. As shown in FIG. 3, the IMS-based SRF 220 may publish storage events via SIP messaging/signaling. The SIP messages as set forth herein generally may include SIP messages that may include content identifiers for identifying cache content associated with the SRF 220-1, 220-2 or 220-N.

In an embodiment, a subscribe/notify operation may be used for event reporting. An entity such as a SRB 260 may subscribe to receive the events from a SRF 220. The SRF 220 may notify or may report the events to the SRB 260, including a new content object that may be cached, an existing content object that may be deleted, and/or available storage space that may be changed, among others.

FIG. 4 illustrates example signaling for event reporting. Referring to FIG. 4, the contents traversing the SRF (e.g. SRF 220-1) may be cached by the SRF 220-1. At 410, the SRB 260 may send a message (e.g., a SIP SUBSCRIBE message/signal) to enable the SRB 260 to subscribe to an event. The SIP SUBSCRIBE message may be routed to the appropriate SRF (e.g., SRF 220-1). The SRF 220-1 may then send a SIP NOTIFY message back to the SRB 260 (e.g., the subscriber) whenever the event of interest that may be subscribed to occurs. The SIP SUBSCRIBE message may include information to identify the event of interest (e.g., information for the SRF 220-1 to publish, notify, and/or report its storage events) including new content objects that may be cached, existing content object that may be deleted, and changes to available storage space of the SRF 220-1. At 420, the SRF 220-1 may respond to the SRB 260 a SIP 200 OK signal.

At 430, the SRF 220-1 may inform the SRB 260 of the cache event so that the SRB 260 may be informed that the SRF 220-1 has cached the contents (e.g., a content object). For example, in responsive to a cache content event at the SRF 220-1, the SRF 220-1 (e.g., after the subscription 410 and 420) may send to the SRB 260, a SIP NOTIFY message indicating a cache event. At 440, the SRB 260 may respond, for example, by sending to the SRF 220-1 a SIP 200 OK message for acknowledgement.

When other contents are cached by the SRF 220-1, the operations may be repeated to notify the SRB 260 of those contents. At 450, the SRF 220-1 may send a further SIP NOTIFY message to the SRB 260 to inform the SRB 260 of a further cache event so that the SRB 260 may be informed that the SRF 220-1 has a particular cache event concerning a respective content. At 460, the SRB 260 may respond to the reception of the further SIP NOTIFY message, for example, by sending to the SRF 220-1 a SIP 200 OK message for acknowledgment. Other cache event(s) may be reported to the SRB in a similar fashion.

In an embodiment, the SRF 220-1 may not operate using SIP messaging. An adapter may be used to translate between another protocol and SIP protocol. It is contemplated that an adapter may be used to enable an SRB 260 using a first protocol to operate with a SRF using a second protocol.

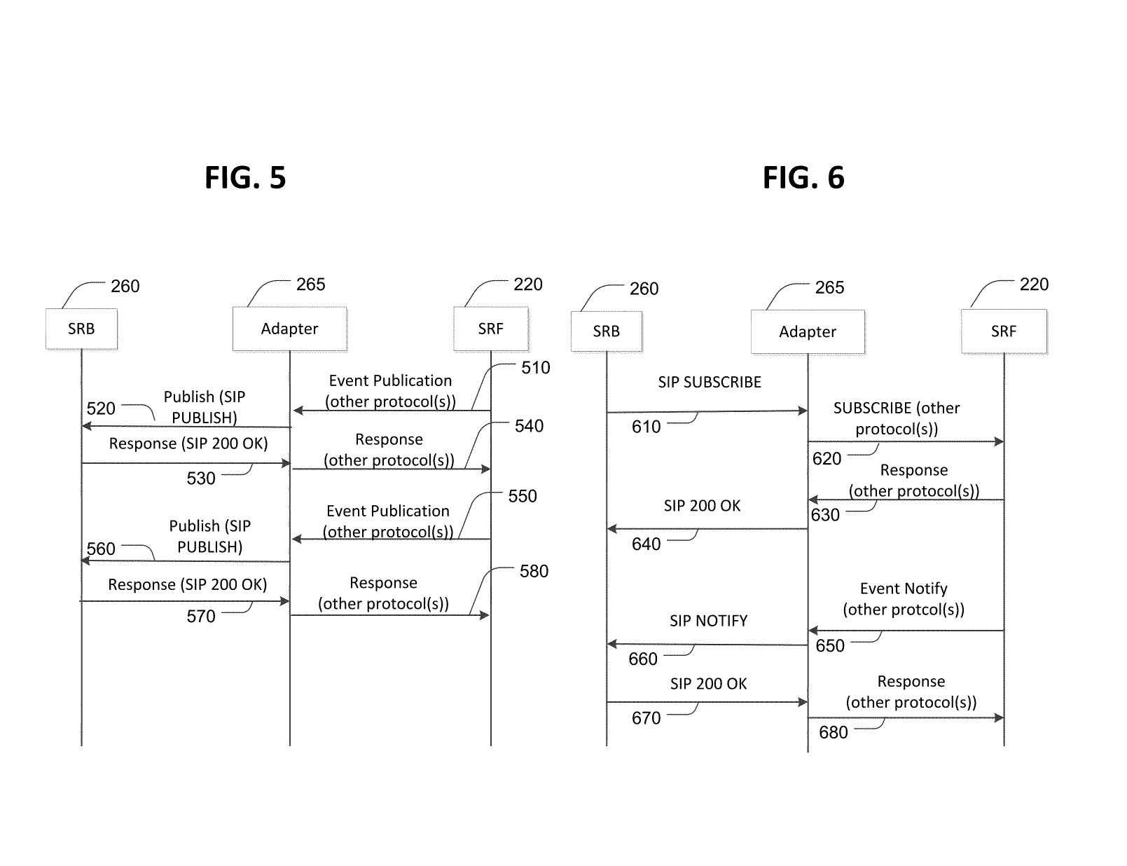

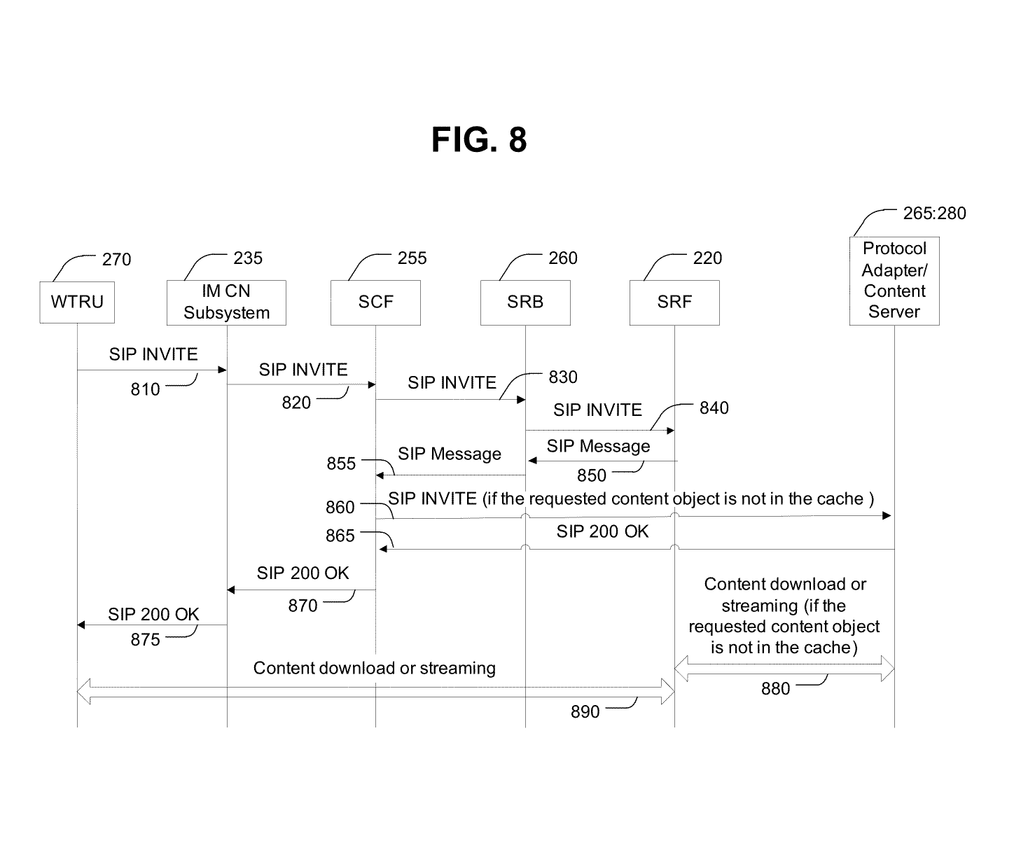

If a SRF is non-IMS, an adapter may be used for communications between the SRF and other IMS elements such as the SRB and the SCF. FIGS. 5-6 and 8 include such an adapter for which FIG. 5 shows the signaling diagram for a non-IMS SRF to publish the storage events that may have occurred in its storage through an adapter which may conduct protocol translation and FIG. 6 shows the signaling diagram for a non-IMS SRF to report the storage events using a subscribe/notify operations, and FIG. 8 shows a signaling diagram for a non-IMS-based SRF to publish its storage events.

FIG. 5 illustrates example signaling for event reporting using an adapter. As shown in FIG. 5, the SRB 260 and the SRF 220 may communicate via an adapter 265. Contents traversing the SRF 220 may be cached by the SRF 220. At 510, upon the occurrence of a cache event, the SRF 220 may send a message (e.g., an event publication or a notification) in a first protocol (e.g., a protocol other than a SIP protocol) to the adapter 265. The adapter 265 may receive the message sent by the SRF 220 and may translate the message into a SIP PUBLISH message. At 520, the adapter 265 may send the translated SIP PUBLISH message to the SRB 260 to inform the SRB 260 of the cache event.

At 530, the SRB 260 may respond to the SIP PUBLISH message/signal by sending to the adapter 265, a SIP 200 OK signal/message. The adaptor 265 may translate the SIP 200 OK message into a translated message in the first protocol of the SRF 220. At 540, the adapter 265 may send the translated message in the first protocol to the SRF 220, as an acknowledgement. When other contents are cached by the SRF 220, at 550, 560, 570 and 580, similar or identical to 510, 520, 530, and 540 may be completed to publish the caching of those contents.

FIG. 6 illustrates example signaling for event reporting using an adapter. Referring to FIG. 6, contents traversing the SRF 220 may be cached by the SRF 220. At 610, the SRB 260 may send a message (e.g., an event publication, a notification and/or a SIP SUBSCRIBE message) in a first protocol (e.g., in a SIP protocol) to the adapter 265. The adapter 265 may receive the message sent by the SRB 260 and may translate the message into a message in a second protocol (e.g., different from the first protocol) of the SRF 220. At 620, the adapter 265 may send the translated subscribe message to the SRF 220 to inform the SRF 220 that the SRB 260 requests to subscribe to one or more cache events. At 630, the SRF 220 may respond to the translated subscribe message by sending to the adapter 265, a response message (e.g., an acknowledgment) in the second protocol. The adaptor 265 may translate the response message in the second protocol to the first protocol (e.g., a SIP 200 OK signal/message in the SIP protocol) of the SRB 260. At 640, the adapter 265 may send the translated response message in the SIP protocol to the SRB 260, as an acknowledgement.

After the SRB 260 subscribes to cache events of the SRF 220, at 650, the SRF 220 may send a message (e.g., an event publication or a notification) in the first protocol (e.g., other than a SIP protocol) to the adapter 265. The adapter 265 may receive the message sent by the SRF 220 and may translate the message into a SIP NOTIFY message. At 660, the adapter 265 may send the SIP NOTIFY message to the SRB 260 to inform the SRB 260 of the cache event. At 670, the SRB 260 may respond to the SIP NOTIFY message by sending to the adapter 265, a response message (e.g., a SIP 200 OK message) in the SIP protocol. The adaptor 265 may translate the SIP 200 OK message in the SIP protocol to a second protocol of the SRF 220 (e.g., a response message in the second protocol). At 680, the adapter 265 may send the translated response message in the second protocol to the SRF 220, as an acknowledgement.

When other contents are cached, deleted or available space is changed by the SRF 220, operations similar or identical to 650, 660, 670 and 680 may be completed to notify the SRB 260 of cache event associated with the contents.

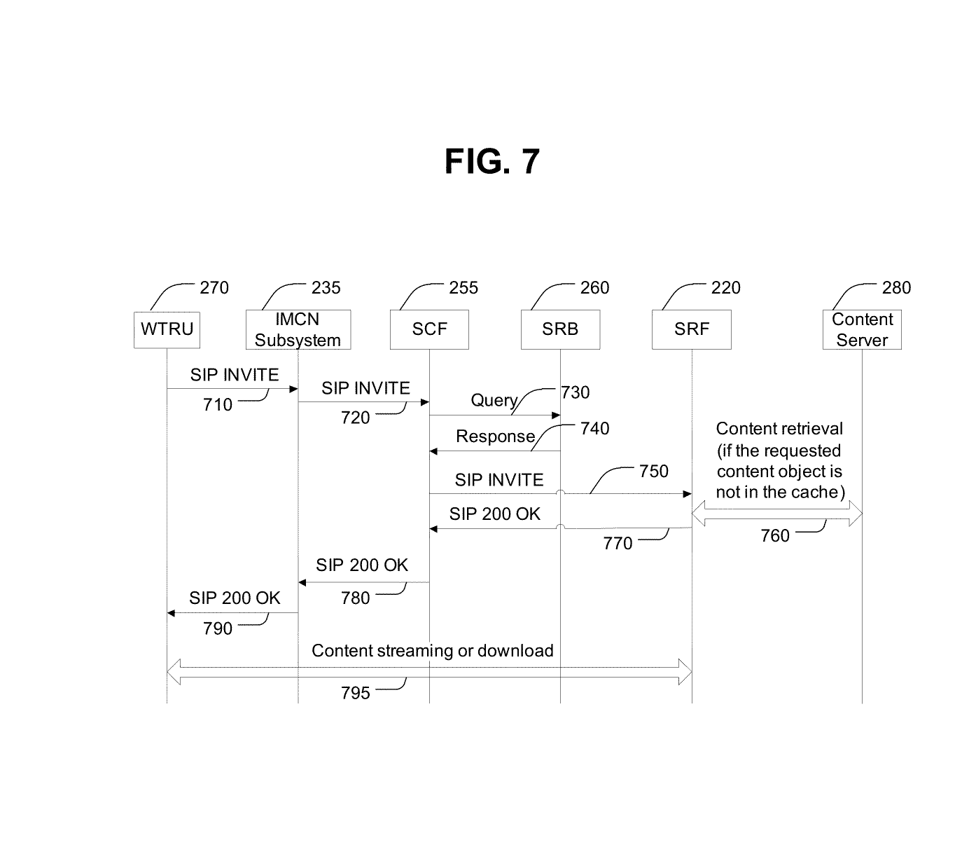

FIG. 7 illustrates example signaling for establishing a content distribution or streaming session. Referring to FIG. 7, the SRF 220 may operate in the managed/on-demand mode, and the SRB 260 may operate in the query mode. The SRF 220 may or may not cache particular content of the content server 280.

As shown in FIG. 7, at 710, the WTRU 270 may send a message such as an invitation or a SIP INVITE message, to the IM CN subsystem 235 indicating an invite for establishing a session (e.g., a media session). The SIP INVITE message may allow the WTRU 270 to establish a session with content server 280, e.g., the WTRU 270 retrieving content from the content server 280. At 720, the IM CN subsystem 235 may send or forward the invitation message (e.g., the SIP INVITE message) to the SCF 255. The invitation message may include the content ID associated with the content to be retrieved and the address of the content server 280.

At 730, the SCF 255 may query the SRB 260 for information regarding the content to be retrieved. For example, the SCF 255 may request information associated with a SRF 220 that may have cached the content based on the content identifier and the content server's address (e.g., an IP address) in the received query. In an embodiment, the SCF 255 may request information associated with a SRF 220 that may be intermediate to the content server 280. At 740, the SRB 260 may send a query response to the SCF 255 indicating a name and/or address of a SRF 220 (e.g., 220-1) that may have cached the content. At 750, the SCF 255 may send a message (e.g., a SIP INVITE message) to the SRF 220. The SRF 220 may determine whether it has cached the content based on the content ID in the received SIP INVITE message.

Responsive to a determination that the content not being cached or stored in the SRF 220, at 760, the content may be retrieved from the content server 280 and stored (e.g., cached) by the SRF 220. For example, a session between the SRF 220 and the content server 280 may be established for streaming or downloading the content. For example, upon receiving the SIP INVITE message/request, the SRF 220 may retrieve the requested content according to instruction included in the SIP INVITE message/request. The retrieval method may include downloading or streaming, using Hypertext Transfer Protocol (HTTP), Real Time Streaming Protocol/Real-time Transport Protocol (RTP/RTSP) and/or other protocols, among others. Upon a determination that the content is cached or stored in the SRF 220, 760 may be skipped. At 770, the SRF 220 may respond to the SIP INVITE message by sending a SIP 200 OK message to the SCF 255.

In an embodiment, the source of the content may be from another server (e.g., content server 280-N) that may be in or out of the mobile service provider network or ISP network, another SRF (e.g., SRF 220-N), and/or, a CDN. The content may be live streaming content or on-demand content. If there is not enough storage or memory available at the SRF 220, the SRF 220 may remove some existing contents. Removal of existing cached content may be based on the instruction from the SCF 255 and/or local policy (e.g., the least recently used content may be first deleted).

At 780, the SCF 255 may send a SIP 200 OK message to the IM CN subsystem 235. At 790, the IM CN subsystem 235 may send a SIP 200 OK message to the WTRU 270 such that a session between the WTRU 270 and the SRF 220 may be established. At 795, the SRF 220 may stream or download the content to be retrieved from the SRF 220 via the established session.

Although operations are shown in FIG. 7 to cache the content to the SRF 220 prior to streaming the content to the WTRU 270, it is contemplated that if the SRF does not have the content stored or cached, the SCF may be informed at 760. The SCF may establish a session directly between the WTRU 270 and the content server 280 for such streaming or downloading.

In an embodiment, the initial SIP INVITE request generated by the WTRU 270 may include, the uniform resource identifier (URI), name, binary identifier, and/or public service identity of the requested content object or item, among others. The IM CN subsystem 235 may handle the SIP message and routes the message to the SCF 255.

In an embodiment, for example, upon receipt of a SIP INVITE message from the IM CN subsystem 235, the SCF 255 may examine the requested URI or content identifier. The SCF 255 may determine whether to use a storage resource such as an intermediary SRF 220 that may have cached the content. The decision may be made based on a policy or rule (e.g., based on the content type and/or popularity, among others). According to the user subscription information, the SCF 255 may check the service rights of the requested content service. If a storage resource may be used, the SCF 255 may query the SRB 260. If multiple SRBs 260 may be used, the SCF 255 may select a SRB 260 to query.

In an embodiment, the SRB 260 may redirect the SCF 255 to query another SRB 260. For example, the SRB 260 may determine that the SRF 220-2 under the redirected SRB 260 may better serve the request, and may redirect the SCF 255 to query that the SRF 220-2. The SCF 255 may receive a response from the selected SRB 260 to redirect to another SRB 260. The SCF 255 may send a query to the redirected SRB 260 for information associated with the SRF 220-2.

In an embodiment, upon receiving the query, the SRB 260 may select a SRF 220. The selection may be made based on whether the requested content has been cached in a SRF 220, the path quality from the SRF 220 to the requestor WTRU 270, the available storage, or memory space, and/or the load (on the source content server) and/or available bandwidth of the SRF 220. The SRB 260 may send a response message to the SCF 255 that may include information such as the selected SRF 220 and whether the requested content has been cached in the selected SRF (e.g., SRF 220-1) or another SRF (e.g., SRF 220-2). The response message may include instructions as to the content that may be removed or memory available in the selected SRF 220-2.

FIG. 8 illustrates example signaling for establishing a content distribution or streaming session. The SRF 220 may operate in the managed/on-demand mode, and the SRB 260 may operate in the in-line service mode with SRF 220.

Referring to FIG. 8, the SRF 220 may or may not cache particular content of the content server 280. At 810, the WTRU 270 may generate an initial SIP INVITE request and may send the initial SIP INVITE request to the IM CN subsystem 235 for establishing a session (e.g., media session) with the WTRU 270. The request may include the URI, name, binary identifier, and/or public service identity of the requested content object or item, among others.

The WTRU 270 may establish a session with the content server 280 to retrieve content from the content server 280 via a SIP INVITE message. At 820, the IM CN subsystem 235 may send (e.g., or forward) a SIP INVITE message to the SCF 255. Upon receipt of the SIP INVITE request, the SCF 255 may examine the requested URI or content identifier. The SCF may determine whether to use the storage resource. The decision may be made based on an established policy. For example, according to the user subscription information, the SCF 255 may check the service rights of the requested content service. Based on a determination to use a storage resource, the SCF 255 may select a suitable SRB 260 and forward (or send) the SIP INVITE message to the selected SRB 260 at 830. The parameters in the original SIP INVITE may be changed according to the selected SRB 260. The SCF 255 may receive a response from the selected SRB 260 to redirect to another SRB 260. The SCF 255 may forward the SIP INVITE to the redirected SRB 260. The parameters in the original SIP INVITE may be changed based on the redirected SRB 260.

At 840, the SRB 260 may send a SIP INVITE message to the SRF 220. The SIP INVITE message may include the content identifier of the content to be retrieved and/or the address of the content server. If the content is stored or cached on the SRF 220, at 850, the SRF 220 may send a SIP 200 OK message to the SRB 260.

In an embodiment, a sequence of SIP 200 OK messages at 855, 870 and 875 may be sent for establishing the session between the WTRU 270 and the SRF 220. If the SRF 220 does not have the content stored or cached, a SIP error message may be sent from the SRF 220 to the SRB 260 at 850 and the SCF 255 at 855 (e.g., a SIP 500 message may be sent indicating that the SRF may not have the content cached). At 860, upon receiving the SIP error message, the SCF 255 may send a SIP INVITE message to a protocol adapter 265 (e.g., for translation by the protocol adapter 265 and then forwarding to a non-SIP content server 280) or to the content server 280.

At 865, the adapter or content server may send a SIP 200 OK message to the SCF 255. At 870, the SIP 200 OK message may be forwarded to the IM CN subsystem 235, and to the WTRU 270 at 875. Because the SRF 220 has been informed about the content to be retrieved, at 880, the SRF 220 may setup a communication session with the content server 280. The SRF 220 may download or stream the content via the communication session. The communication may be directly between the SRF 220 and the content server, or via the adapter 265. At 890, the WTRU 270 may stream or download the content to be retrieved from the SRF 220.

In an embodiment, the SCF 255 may send the SIP 200 OK response to the IM CN subsystem 235. For example, the SCF 255 may send the SIP 200 OK response to the IM CN subsystem 235 upon receiving a SIP 200 OK response from the SRF 220 at 855. For example, the SCF 255 may send the SIP 200 OK response to the IM CN subsystem 235 upon receiving a SIP 200 OK response from the protocol adapter/content server 265:280 at 865.

The SCF 255 may add the server location information of the content to be streamed or downloaded, e.g., the selected SRF 220 to the SIP 200 OK response. The SCF 255 may change other parameters in the SIP message based on the caching information.

In an embodiment, after receiving a SIP 200 OK response, the WTRU 270 may start the content streaming or download session according to the information in the response. The streaming/download server or source may include the SRF 220. If a SRF 220 is non-IMS compliant, a protocol adapter may be used for communications between the SRF 220 and other IMS elements such as the SRB 260 and the SCF 255.

In an embodiment, the SCF 255 may send the SIP INVITE request to the selected SRF (e.g., SRF 220-2). The SIP message may include an instruction to the SRF 220-2 to serve the request. If the SRF 220-2 does not have the requested content object, the SIP INVITE request/message may include the instruction about the location and the method (or protocol) to obtain the content or content object. The request may include the instructions to remove the content if storage or memory available in the selected SRF 220-2 is insufficient.

If the requested content object is not cached or stored on the selected SRF 220-2, the SCF 255 may set up a session for downloading the content object or streaming the content object from the content server 280. For example, the SCF 255 may select a suitable protocol adapter/content server 265:280 and may forward or send the SIP INVITE message to the selected adapter/content server 265:280.

In an embodiment, the SCF 255 may receive a response from the selected protocol adapter/content server 265:280 to redirect to another protocol adapter/content server. The SCF 255 may send a SIP INVITE request to the redirected protocol adapter/content server. The SCF 255 may send another SIP INVITE message (e.g., through the SRB 260) to the selected SRF 220-2 to trigger the SRF 220-2 to start retrieving (download or streaming) the content from the origin content server after receiving a SIP 200 OK message from the protocol adapter/content server 265:280 and the SRF 220-2 may send a SIP response message (e.g., through the SRB 260) to the SCF 255. The URI and/or content identifier and the method/protocol for obtaining the content may be included in the SIP message.

In an embodiment, the SCF 255 may not send the SIP INVITE message to the origin protocol adapter/content server 265:280. The SCF 255 may instruct (e.g., through the SRB 260) the SRF 220-2 to retrieve the content or content object from the content server 280. The URI or content identifier and the method/protocol for obtaining the content may be included in the SIP INVITE message.

In an embodiment, the SCF 255 may send the SIP INVITE request(s) to the SRF 220-2 prior to sending the SIP INVITE request to the protocol adapter/content server 265:280. In an embodiment, the SCF 255 may send the SIP INVITE request(s) to the protocol adapter/content server 265:280 prior to sending the SIP INVITE request to the SRF 220-2.

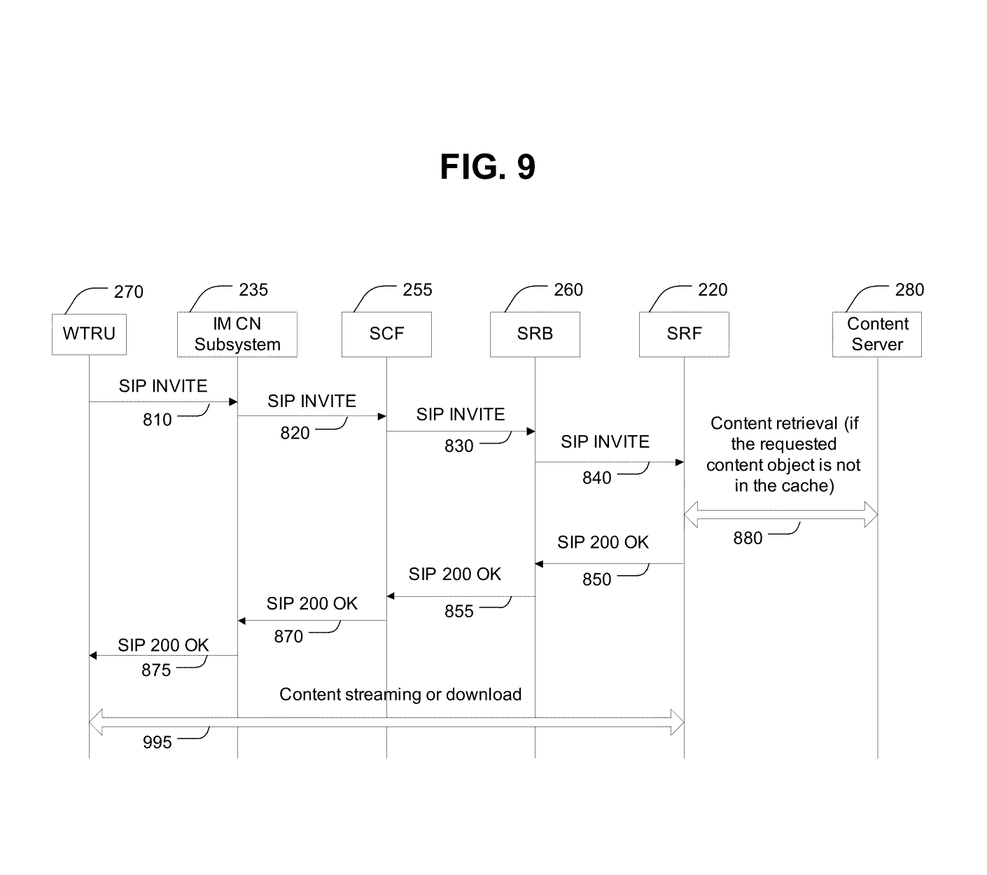

FIG. 9 illustrates example signaling for establishing a content distribution or streaming session. For example, the SRF 220 may operate in the managed/on-demand mode and the SRB 260 may operate in the in-line mode with the SRF.

The operations shown in FIG. 9 may be substantially similar to those shown in FIG. 8, except that the SRF 220 may send a SIP 200 OK response to the SRB 260 regardless of whether the request content is cached or stored on the SRF 220. For example, upon receiving the SIP INVITE request, the SRB 260 may select a SRF 220. The selection may be made based on whether the requested content is cached in the SRF 220, the delivery path quality from the SRF 220 to the requested WTRU 270, the available storage or memory space, and/or the load and/or available bandwidth of the SRF 220. The SRB 260 may change the parameters in the SIP INVITE request based on the selected SRF 220. The SRB 260 may send or forward the SIP INVITE request to the selected SRF 220. The SIP message may include an instruction to the SRF 220 to serve the request. The SIP message may include instructions as to the content that may be deleted if there is not enough storage or memory available in the selected SRF 220. If the SRF 220 does not have the requested content or content object, the SIP INVITE message may include the instruction on a location and a method or a protocol for obtaining the content. After receiving a SIP 200 OK response from the SRF 220, the SRB 260 may forward the response to the SCF 255 after changing parameters in the SIP response accordingly. In an embodiment, the SRB 260 may redirect the SCF 255 to another SRB. For example, the SRB 260 may redirect the SCF 255 to another SRB upon a determination that a redirected SRB may better serve the request.

In an embodiment, the SCF 255 may determine whether the requested content is stored or cached on the selected SRF 220, for example, based on the response of the SRB 260. Upon a determination that the requested content is unavailable on the selected SRF 220, the selected SCF 255 may select a content server 280 and may send a SIP INVITE request to the selected content server 280. The SCF 255 may receive a response from the selected content server (e.g., content server 280-1) to redirect to another content server (e.g., content server 280-N). The SCF 255 may send a SIP INVITE request to the redirected content server 280.

The SCF 255 may send another SIP INVITE message (e.g., through the SRB 260) to the selected SRF 220 to trigger the SRF 220 to retrieve (download or streaming) the content from the origin content server 280. The SRF 220 may send a SIP response message (e.g., through the SRB 260) to the SCF 255. The URI, the content identifier and/or the method/protocol for obtaining the content may be included in the INVITE request message.

In an embodiment, the SCF 255 may instruct (e.g., through the SRB 260) the SRF 220 to retrieve the content object from the content server 280, as shown in FIG. 9.

Upon receipt of the SIP INVITE request, the SRF 220 may determine whether the requested content is cached locally. Upon a determination that the requested content is not cached locally, the SRF 220 may retrieve the requested content, for example, based on the instructions included in the request. The retrieval method may be download or streaming, using HTTP, RTSP/RTP or other protocols.

The content server 280 may include an origin content server in or out of the mobile service provider or ISP network, another SRF 220, and/or from a CDN. The content may include live streaming content and/or on-demand content. The SRF 220 may send a SIP response to the SRB 260.

As shown in FIG. 9, at 995, the WTRU 270 may start the content streaming or download session with the SRF 220 according to the information in the response.

The SIP messages may be configured to carry the caching information and parameters. For example, the first SIP INVITE message sent by the WTRU may carry information to indicate to the SCF 255 that the WTRU 270 may allow the content object to be served from a cache node. If the WTRU 270 desires to receive the content or content object from the origin content server, then the objects may be served from the origin content server. A SIP OK message, such as the last SIP OK message from the SCF 255, may carry the information about cache validity. The WTRU 270 may use the included information to determine when to request a new copy for the content or content object.

A network operator (NO) may deploy SRFs. The SRFs may serve as network peers (NPs) for distributing content via peer-to-peer (P2P) services. An SRF may cache content and form one or more P2P network(s) with other user devices or SRFs for content retrieval and distribution. An SRF may join one or more P2P network swarms and may act as a seed or super node for multiple P2P swarms. In an embodiment, SRFs may be more stable and powerful (e.g., with better communication quality, bandwidth capabilities, and/or throughput) than end typical user devices. With SRFs serving as network peers, churn and delay problems that may occur in traditional user-to-user P2P streaming may be reduced. In an embodiment, a CCS may include a SRF. In an embodiment, an SRF may include a CCS, and the two terms may be used interchangeably herein.

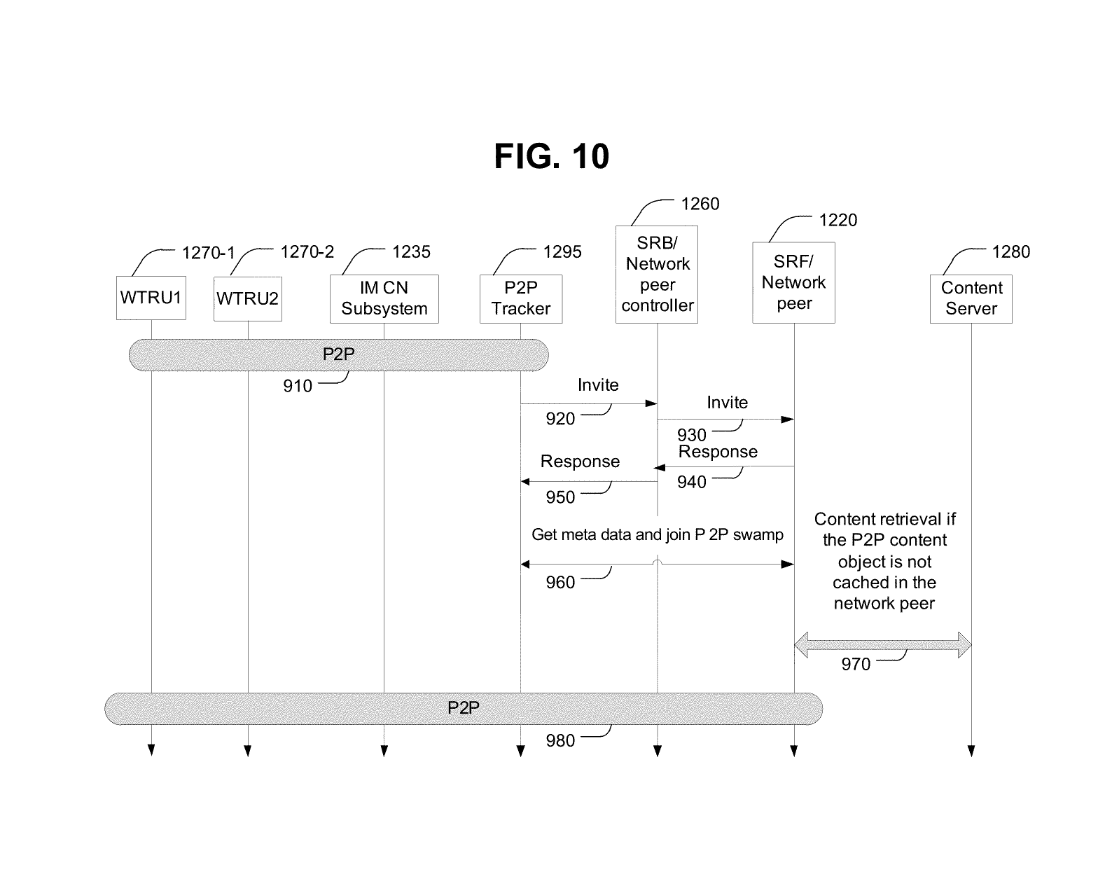

FIG. 10 illustrates an example signaling for a peer node to join a Peer-to-Peer (P2P) swarm for retrieving stored content. For example, the SRB 1260 may include a network peer controller, and may operate in an in-line service mode. The SRF 1220 may be selected to serve as a network peer (NP). The SRF 1220 may receive instructions to join the P2P network swarm as a NP. The SRF 1220 may retrieve the content or content object from a content server 1280.

Referring to FIG. 10, at 910, a P2P swarm may be formed. As shown, the P2P swarm may include one or more nodes such as the WTRU1 270-1, WTRU2 270-2, and the P2P tracker 1295. At 920, the P2P tracker 1295 may send an invite message such a SIP INVITE message for establishing a session with the SRF/NP 1220. The invite message may be sent to the SRB/NPC 1260. At 930, the SRB/NPC 1260 may forward the invite message, or send a separate invite message to the SRF/NP 1220. At 940, the SRF/NP 1220 may send a response message such as a SIP 200 OK message, to the SRB/NPC 1260. At 950, the SRB/NPC 1260 may forward the response message, or send a separate response message, to the P2P tracker 1295, such that a session between the P2P tracker and the SRF/NP 1220 may be established. At 960, the P2P tracker 1295 and the SRF/NP 1220 may exchange joining information such that the SRF/NP 1220 may join the P2P swarm. Joining information may include metadata such as the address of the SRF/NP 1220, and the peer list such as the successor and/or predecessor of the joining SRF/NP 1220.

In an embodiment, the SRF/NP 1220 may serve as an intermediary P2P node for content retrieval between P2P nodes such as WTRU1 1270-1 to the WTRU2 1270-2. For example, the SRF/NP 1220 may serve as an intermediary P2P node when the signal quality between origin node and the destination node is below a predetermined threshold, and/or when the origin node and the destination node cannot directly communicate with each other due to protocol incompatibility, and/or other bandwidth constraints.

At 970, the SRF/NP 1220 may retrieve the content from the content server 1280. For example, the SRF/NP 1220 may determine whether to download the requested content from a content server 1280. In an embodiment, the SRF/NP 1220 may determine to download the content if the requested content object is not cached locally in the SRF. In an embodiment, the SRF/NP 1220 may determine to download the content if the nodes of the P2P swarm do not have the content available for retrieval, and/or if the node having the content to be retrieved is not reachable. Based on the determination, the SRF/NP 1220 may retrieve the content.

At 980, the P2P swarm may communicate via P2P services. For example, the P2P swarm may communicate such that the SRF/NP 1220 may act as an intermediary node for content retrieval between a network peers such as the WTRU1 1270-1 and WTRU2 1270-2.

For example, the P2P tracker 1295 may invite or instruct the SRF/NP 1220 to join the P2P network swarm as a network peer. The P2P tracker 1295 may send an invite message, such as a SIP INVITE request to the SRF/NP 1220. The invite message may include instruction for obtaining metadata relating to a P2P content swarm. The SRF/NP 1220 may send a response message to the P2P tracker 1295. The SRF/NP 1220 may obtain the P2P metadata such as peer list, and/or content metadata, among others, and may join the P2P swarm. If the SRF/NP 1220 does not have the P2P content or content object stored therein, the P2P tracker 1295 may instruct the SRF/NP 1220 to retrieve the content object from the content server 1280. The P2P tracker 1295 may inform the SRF/NP the location and method or protocol to obtain the content or content object. The content server 1280 may be within or outside the operator's network domain.

In an embodiment, the SRB/NPC 1260 may operate in an in-line service mode, and may instruct the selected SRF/NP 1220 to join the P2P network swarm as a network peer.

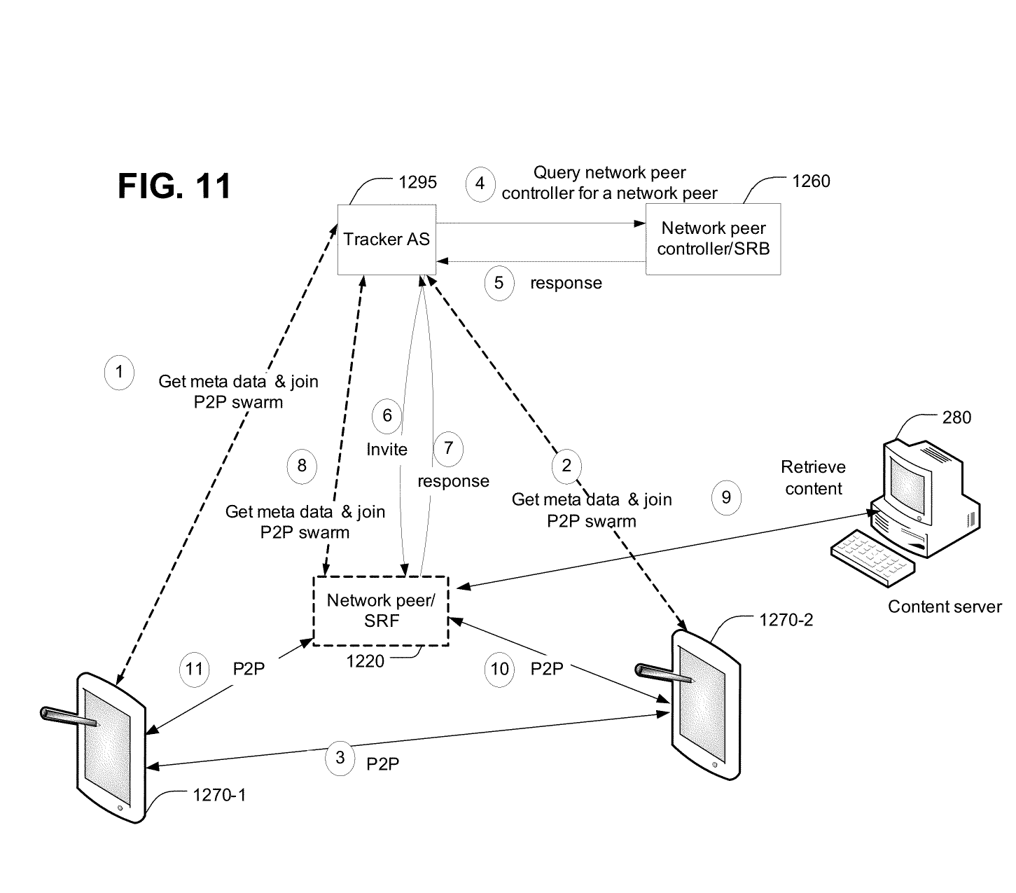

FIG. 11 illustrates a P2P content distribution system having a SRF serving as a network peer. As shown, at 1 and 2, one or more devices such as WTRU 1270-1 and the WTRU 1270-2 may obtain metadata relating to a P2P swarm and may join the P2P network. At 3, the WTRU 1270-1 and the WTRU 1270-2 may establish a P2P session. At 4, the P2P tracker AS 1295 may query the SRB/NPC 1260 for a network peer. For example, P2P tracker AS 1295 may determine to invite a network peer based on certain desires, rules and/or policies, for example, a policy to improve the P2P swarm performance when a new WTRU joins the P2P swarm or the network conditions change. The P2P tracker AS 1295 may determine to invite a network peer when the performance of the P2P swarm falls below a predefined threshold, and may need to be improved. In an embodiment, the SRB/NPC 1260 may respond with a set of available network peers and the P2P tracker AS may select the network peer.

At 5, the SRB/NPC 1260 may send a response message to the tracker AS 1295 indicating one or more selected network peer(s) and/or whether the P2P content has been cached in the selected network peer(s). At 6, the tracker AS 1295 may send a SIP INVITE message to the selected network peer such as SRF/NP 1220. At 7, the SRF/NP 1220 may send a response message indicating an acceptance of the invitation to join the swarm. At 8, the P2P tracker 1295 and the SRF/NP 1220 may exchange joining information such as metadata that may include the address of the SRF/NP 1220, and/or the peer list (e.g., successor and/or predecessor of the joining SRF/NP 1220) such that the SRF/NP 1220 may join the P2P swarm. At 9, the tracker AS 1295 may instruct the SRF/NP 1220 to retrieve a content or content object from a content server 1280 and may distribute the content using P2P communication.

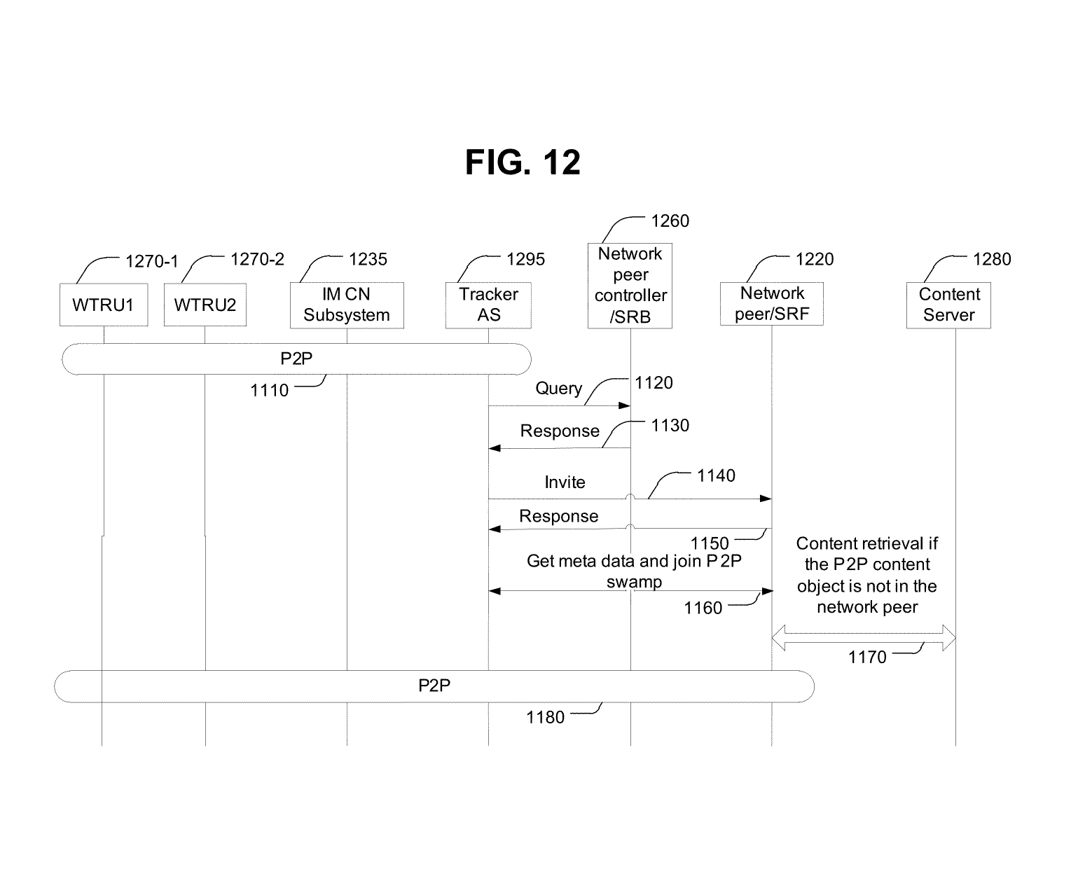

FIG. 12 illustrates example signaling for a SRF to serve as a network peer in a P2P swarm. At 1100, a P2P swarm may be formed and may include the P2P tracker 1295 and peer nodes such as the WTRU 1270-1, the WTRU 1270-2. In an embodiment, the SRBs (e.g., SRB/NPCs 1260) may include network peer controller functions. The SRFs (e.g., SRF/NPs 1220) may serve as network peers. The messages shown in FIG. 12 may be routed through the IM CN subsystem 1235.

A SRF/NP 1220 may be selected to join a P2P swarm based on one or more policies and criteria. The policies and criteria may include the degree of improvement to the P2P swarm performance; the path quality from the network SRF/NP 1220 to the WTRUs 1270 in the P2P network; the available storage or memory space, the load, the available bandwidth of the SRF/NP 1220; and/or whether the requested content object has been cached in the SRF/NP 1220. The SRB/NPC 1260 may redirect the tracker AS 1295 to query another SRB/NPC. The tracker AS 1295 may query the redirected SRB/NPC.

At 1120, the P2P tracker 1295 may send a query to the SRB/NPC 1260. The SRB/NPC 1260 may send a query as if sending a query to a WTRU 1270. At 1130, the SRB/NPC 1260 may send a response message to the tracker AS 1295 indicating information such as the selected network peer and/or whether the P2P content has been cached in the selected network peer.

At 1140, the tracker AS 1295 may send a SIP INVITE message to the SRF/NP 1220. The SRF/NP 1220 may receive information in the SIP INVITE request. For example, the request may indicate content to be retrieved by the WTRU 1270-1 from the WTRU 1270-2. At 1150, the SRF/NP 1220 may send a response message (e.g., a SIP 200 OK message) to the tracker AS 1295 to establish a session between the P2P tracker and the SRF/NP 1220. At 1160, the P2P tracker 1295 and the SRF/NP 1220 may exchange joining information such that the SRF/NP 1220 may join the P2P swarm. The joining information may include, but not limited to, metadata such as the address of the SRF/NP 1220, and/or the peer list (e.g., successor and/or predecessor of the joining SRF/NP 1220). At 1180, after joining the P2P swarm, the SRF/NP 1220 may serve as an intermediary P2P node (e.g., as an intermediary hop) to stream or download content from a WTRU to another WTRU. For example, the P2P swarm may communicate such that the SRF/NP 1220 may act as the intermediary node for the retrieval of the content from the WTRU 1270-2.

In an embodiment, the functions of the SRB/NPC 1260 may be combined with those of the tracker AS such that the querying of the SRB/NPC 1260 may be internal to the tracker AS 1295.

In an embodiment, if the SRF/NP 1220 does not have the P2P content or content object cached, the SRF/NP 1220 may retrieve a content or content object from a content server 1280, at 1770. The SRF/NP 1220 may derive information associated with retrieving the content, such as the location and method or protocol to obtain the content or content object, from the SIP INVITE message. The content server 1280 may be within or outside the operator's network domain.

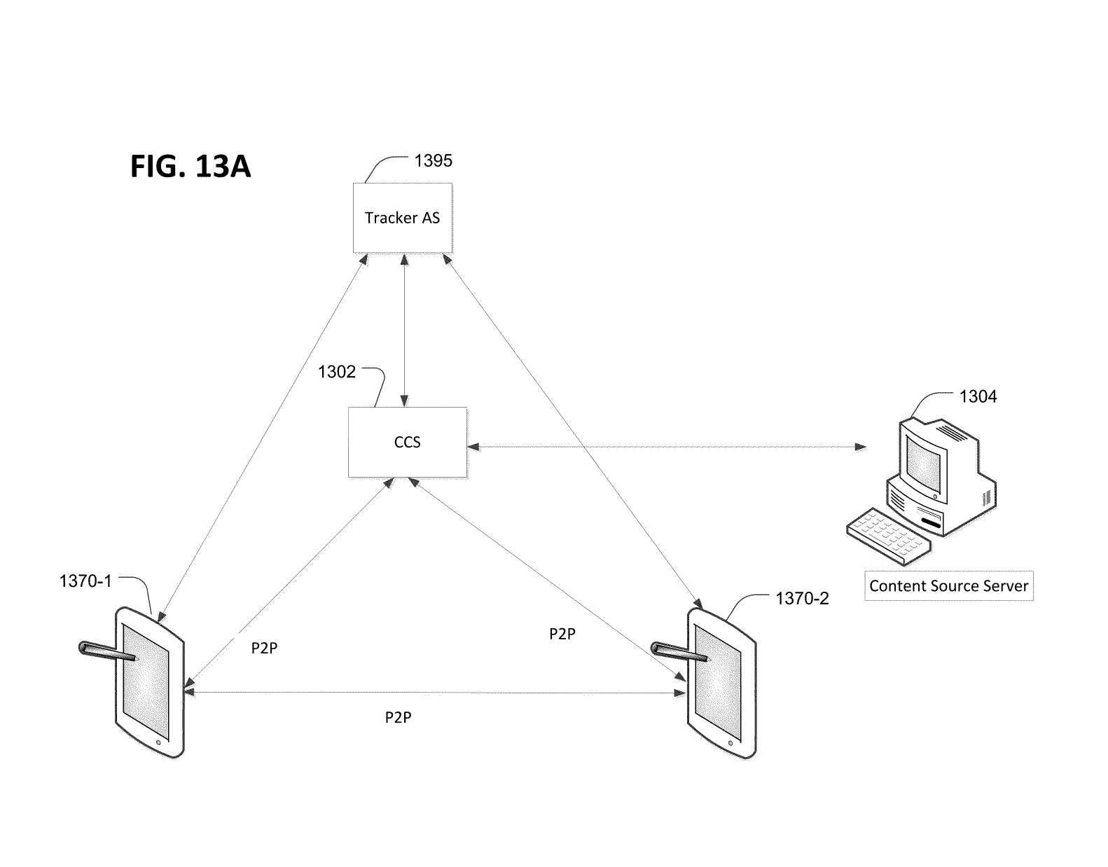

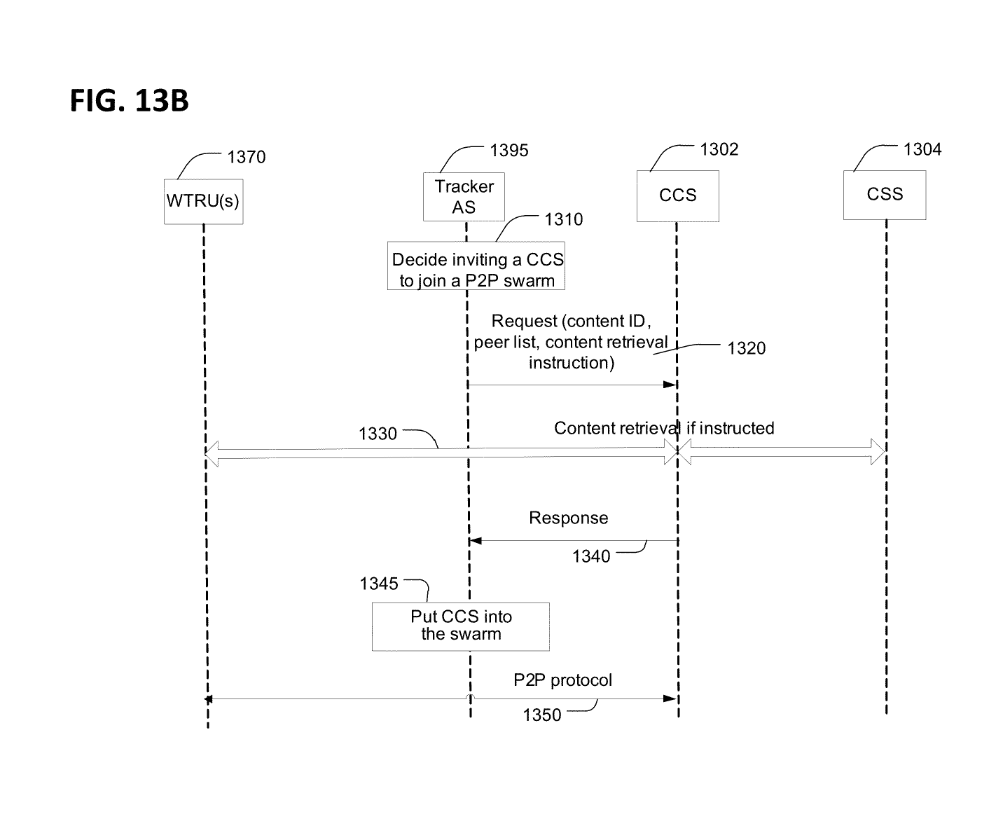

FIG. 13A illustrates example P2P content distribution system having a CCS serving as a peer node. As shown in FIG. 13A, a P2P content distribution system may include one or more peer nodes such as WTRUs 1370. The WTRUs 1370 may substantially correspond to, or include, the WTRU 102 described herein with respect to FIGS. 1A-1E. The system may include a P2P tracker AS such as tracker AS 1395. The tracker AS 1395 may include an IMS application server, and/or a directory server that may maintain a list of peer nodes storing content or content segments, and may answer queries from peers for peer lists. The tracker AS 1395 may include storage for storing the peer list(s), information associated with peer nodes on the peer list(s) and information associated with P2P swarm(s). Storage may include any device with storage (e.g., non-transitory storage) capability, including, but not limited to memory, flash memory, and/or optical or magnetic disk. The tracker AS 1395 may include a processor, such as processor 118 described herein with respect to FIG. 1B. The tracker AS 1395 may include a transceiver, such as a transceiver 120 described with respect to FIG. 1B. The transceiver may be configured to send and receive messages, such as SIP messages.

The system may include one or more CCS such as CCS 1302. A CCS 1302 may include an entity configured to cache partial or entire source content for distribution. The data on a CCS 1302 may be obtained from a content source server (CSS) or other CCS (s) via pre-distribution of the source content or upon users' request. The CCS 1302 may be deployed at the edge of the network to accelerate content distribution. The CCS 1302 may stream, deliver, and/or distribute the content to the WTRUs 1370 and may manage access rights to access the content.

The CCS 1302 may be deployed and controlled by the NO for improving the performance of P2P services. Multiple CCSs 1302 may be deployed in the radio access networks or core networks. The CCS 1302 may be integrated or co-located with a Node-B or an eNode-B 140, an access point, a base station 180, an A-GW 215, an A-BGF 215, an S-GW 164, a P-GW 166, an IBGF 225, a router, and/or a separate element within RANs and/or the CN 106, or the like.

The CCS 1302 may include storage for caching the content and/or content segments. Storage may include any device with storage (e.g., non-transitory storage) capability, including, but not limited to memory, flash memory, and/or optical or magnetic disk. The CCS 1302 may include a processor, such as processor 118 described with respect to FIG. 1B. The tracker AS 1395 may include a transceiver, such as a transceiver 120 described with respect to FIG. 1B. The transceiver may be configured to send and receive messages, such as SIP messages. In an embodiment, the CCS 1302 may be configured to communicate with other network entities, such as the Tracker AS via SIP protocol.

The CCS 1302 may provide the content and/or content segments to the IMS based P2P content distribution services (IMS P2P CDS) WTRUs 1370 under the direction of tracker AS 1395. A CCS 1302 may cache different contents and may form P2P networks with different sets of WTRUs 1370 and CCSs 1302 for retrieval of different contents. A CCS 1302 may join multiple P2P swarms and may act as a seed or super node for multiple P2P swarms. In an embodiment, the CCSs 1302 may be more stable and powerful (e.g., with better communication quality, bandwidth/throughput, processing and storage capabilities) than WTRUs 1370.

With CCSs 1302 in a P2P swarm, P2P quality may be improved. For example, the tracker AS 1395 may instruct a CCS 1302 to join the P2P swarm based on a status of the P2P swarm (e.g. underlying network condition changes, UEs joining or leaving the swarm, changes in traffic conditions, location, capabilities and/or workload of peers, among others). The tracker AS 1395 may instruct the CCS 1302 to retrieve the corresponding content/content segments, if the P2P content is not available at the CCS 1302. In an embodiment, the CCS 1302 may include one of a plurality of servers for selection by the tracker AS 1395 of the joining CCS. In an embodiment, the CSS 1304 may be one of a plurality of content servers hosting the source content.

As shown in FIG. 13A, a P2P content distribution system may include one or more CSS 1304. Content or content segments may be retrieved from a CCS such as CSS 1304. The CSS 1304 may provide content resources and may execute segmenting of content resources. The CSS 1304 may execute content encoding and transcoding. The CSS 1304 may include any server that may provide, encode, or store content. The CSS 1304 may store the source content, and provision interface for other entities to fetch content. For example, the CSS 1304 may be a social network, a webpage, Facebook, YouTube, or the like.

The WTRUs 1370, the CCS 1302 and the tracker AS 1395 may be in operative communication with each other, for example via a cellular network, an IP network, a Packet Switched (PS) Core, a RAN, a fixed Broadband WLAN Access, and/or the like. For example, an IP Network may include the Internet, an intranet, a WLAN, or the like. The CCS 1302 may be in operative communication with the CSS 1304, such that the CCS 1302 may retrieve content from the CSS 1304.

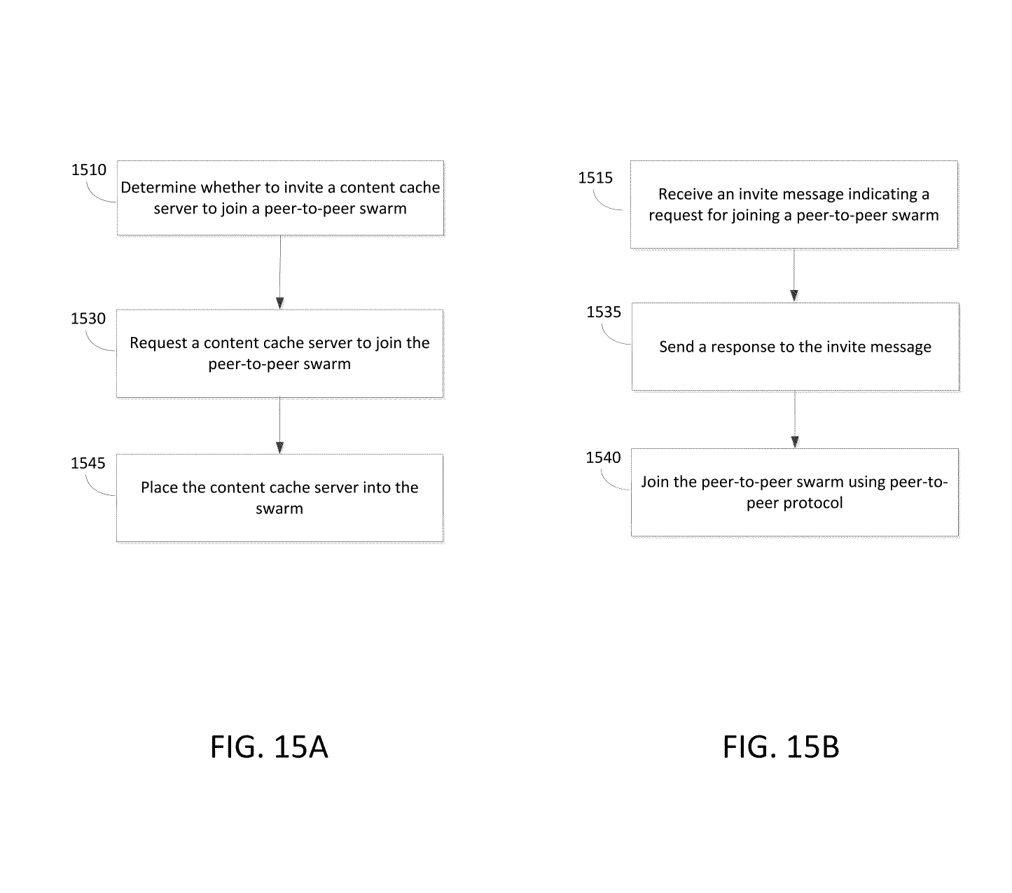

FIG. 15A illustrates example procedure for adding a content cache server to a P2P swarm. In an embodiment, 1510, 1530 and 1545 may be performed by a tracker AS such as tracker AS 1395 described herein with respect to FIGS. 10-14.

As shown, at 1510, whether to invite a CCS to join a P2P swarm may be determined For example, a tracker AS may instruct a CCS to join a P2P swarm based on the status of the P2P swarm. For example, the status may include change(s) to the underlying network condition, new peer(s) joining the swarm, or peer(s) leaving the swarm, changes in traffic conditions such as the path quality between the peers in the swarm, the presence of a CCS within the vicinity of one or more peers in the swarm, the degree of improvement to the P2P swarm performance, the path quality between the CCS and the peer(s) in the P2P swarm, the available storage or memory space on the peers in the swarm, work load of peers, the load associated with peers retrieving content from the content source server, the available bandwidth of a CCS, the proximity of the CCS to one or more peers in the swarm, and/or whether the requested content object has been cached in a CCS.

At 1530, a CCS may be requested to join the peer-to-peer swarm. For example, the tracker AS 1395 may, upon deciding to invite a CCS to the peer-to-peer swarm, request a CCS to join the P2P swarm. At 1545, the CCS may be placed into the swarm. For example, the tracker AS may update the peer list by adding the CCS to the peer list associated with the P2P swarm.

FIG. 15B illustrates example procedure for a content cache server to join a P2P swarm. In an embodiment, 1515, 1535 and 1540 may be performed by a CCS such as CCS 1302 described herein with respect to FIGS. 13A, B and 14. In an embodiment, 1515, 1535 and 1540 may be performed by a WTRU such as WTRU 102 described herein with respect to FIGS. 1A-1E.

As shown in FIG. 15B, at 1515, a request for joining a P2P swarm may be received. For example, a CCS such as CCS 1302 may be requested to join a P2P swarm by a tracker AS 1395. The CCS 1302 may determine whether to join the P2P swarm, for example, based on workload, available storage, content requested, a characteristic of the P2P swarm, a characteristic of the tracker AS and/or usage policy or the like. At 1535, the CCS 1302 may send a response to the invite message. For example, based on a determination to join the swarm, the response may include an indication of accepting the invitation/request to join the P2P swarm. For example, based on a determination to not join the swarm, the response may include an indication of declining the invitation/request. At 1540, the CCS 1302 may join the P2P swarm. The CCS may establish a P2P session with a peer node in the P2P swarm using a P2P protocol.

In an embodiment, the response message may include an indication of another CCS, or an indication to redirect the request to another CCS. For example, the CCS 1302 may determine to not join the swarm, and may determine that another CCS may better serve the request.

In an embodiment, the tracker AS may instruct the CCS to retrieve the corresponding content/content segments from another CSS if the P2P content is not available at the CCS. This signalling flow can use the Tc interface between the tracker AS and the CCS.

FIG. 13B illustrates example signaling for a CCS joining a P2P swarm. For example, the tracker AS 1395 may instruct the CCS 1302 to join a P2P network swarm as a network peer. At 1310, the tracker AS 1395 may select a CCS such CCS 1302 to join the P2P swarm. At 1320, the tracker AS 1395 may send an invite/request message such as a SIP INVITE message to the CCS 1302. The invite/request message may include the content ID and/or the peer list (e.g., a unique identifier of the content and/or information regarding the peer nodes of the P2P swarm). The invite/request message may include content retrieval instruction, such as the instruction to retrieve the content or content segments from the CSS 1304, peer nodes 1370 and/or other CCS(es) (not shown).

At 1330, in response to instructions from the tracker AS 1395 to retrieve content, the CCS 1302 may retrieve content or content segments from the CSS 1304 and/or from peer node(s) such as WTRU 1370, and/or other CCS(es) (not shown). At 1340, the CCS 1302 may send a response to the tracker AS 1395. For example, the response may include a SIP 200 OK response message indicating acceptance of the invite to join the swarm.

The response may indicate successful completion of the instructions included in the invite/request message received at 1320.

At 1345, the CCS may be placed in the swarm. For example, the tracker AS 1395 may put the CCS into the swarm. At 1350, the CCS 1302 may join the P2P swarm using the P2P protocol. For example, the CCS 1302 may stream content/content segments to the WTRU 1370 or download content/content segments from the WTRU 1370.

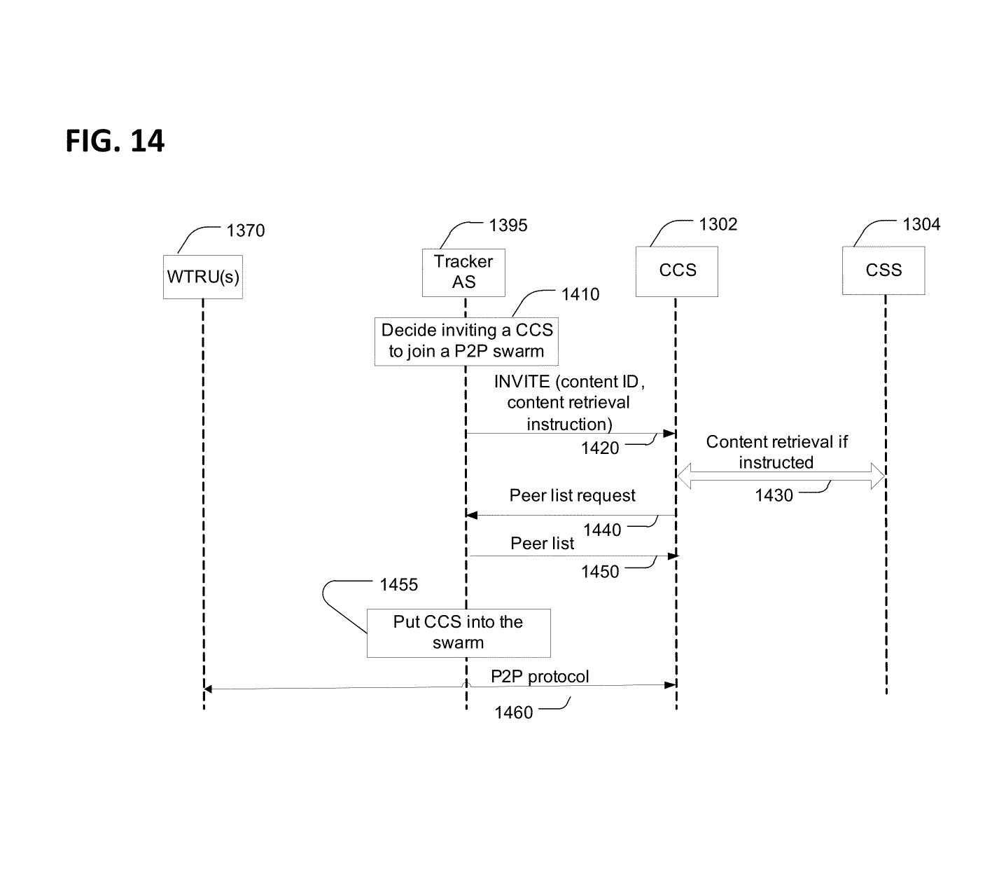

FIG. 14 illustrates example signaling for a CCS to join a P2P swarm. As shown, the tracker AS 1395 may invite the CCS 1302 to join the P2P swarm, and the CCS 1302 may contact the tracker AS 1395 for the peer list.

Referring to FIG. 14, at 1410, the tracker AS 1395 may determine whether to invite the CCS 1302 to join the P2P swarm. At 1420, upon determining to invite the CCS 1302, the tracker AS 1395 may send an invitation message (e.g., using SIP protocol) to the CCS 1302. The SIP INVITE message may include an indicator identifying the desirable content, such as a content ID, and may include the instruction to retrieve the content/content segments from the CSS 1304.

In an embodiment, the CCS 1302 may be one of a plurality of servers for selection by the tracker AS 1395. In an embodiment, the CSS 1304 may be one server of a plurality of servers for retrieval of source content.

At 1430, the CCS 1302 may retrieve the content/content segments (e.g., if so instructed, for example, by the tracker AS 1395). At 1440, the CCS 1302 may send a request to the tracker AS 1395 for the peer list. At 1450, the tracker AS 1395 may send the peer list to the CCS 1302. At 1455, the CCS may be placed in the swarm. For example, the tracker AS 1395 may put the CCS into the swarm. At 1460, the CCS 1302 may join the P2P swarm using a P2P protocol. For example, the CCS 1302 may stream or download content/content segments to the WTRU 1370.

In an example embodiment, the message sequences may include messages such as session progress messages and the acknowledgement message from the WTRU in response to the reception of SIP 200 OK message. Furthermore, messages may be routed through the IM CN subsystem. The SIP messages may carry storage information (e.g., instructing the CCS to download/retrieve and/or cache the content from a server). The SIP messages may carry the CCS storage event report (e.g., indicating a new content object that may be cached, an existing content object that may be deleted, and available storage space that may be changed).

An embodiment may include a method and an apparatus using the method and configured to store the content as the content traverses the apparatus in a media plane, send to an entity using a control plane different from the media plane, a message including a content identifier indicating that the content associated with the content identifier is stored in the apparatus, and receive routed from a requestor via the control plane, a request for the content based on the content identifier. The content routed from the apparatus may be sent to the requestor via the media plane. The request for the content, which may be initially routed via the control plane to a content server, may be redirected to the apparatus. The storing of the content may include caching of the content for at least a first time period.

The apparatus may determine whether to store the content for retrieval based on content storage polices and in response to a determined result, the apparatus may perform the storing of the content and the sending of the message.

The apparatus may determine whether a request for the content has been received and responsive to a request for the content being received, the caching of the content for at least the first time period may be extended to at least a second time period greater than the first time period.

The content identifier may be determined based on one or more attributes of the stored content to identify the content from other stored content on the apparatus. The message including the determined content identifier and an identifier of the apparatus may be generated.

For example, the control plane may include an IP multimedia subsystem, and the media plane may include a wireless communication system and one or more content servers. A connection of the apparatus in the media plane with the requestor in the media plane may be controlled using signaling in the control plane via the IP multimedia subsystem. The content may be sent from the apparatus to the requestor via the media plane exclusive of the control plane.

For example, the apparatus may be one of a plurality of apparatus such that a peer-to-peer network may be formed by the one apparatus with a further apparatus. As part of storing the content, portions of the content may be distributed between or among the plurality of apparatus for storage, each portion being stored in at least one of the plurality of apparatus.

For example, the apparatus may be one of a plurality of apparatus such that one apparatus may be associated with further apparatus to form a peer-to-peer network. As part of sending of the content routed from the apparatus to the requestor via the media plane, one of the further apparatus may be established as an intermediary node between the apparatus, and the stored content may be distributed by routing the stored content from the apparatus to the requestor through the intermediary node.

The messages may include one or more SIP message. The messages may include a SIP PUBLISH message, or a SIP NOTIFY message. The SIP messages may include a content identifier to identify the content to be retrieved, and the content identifier may be independent of the IP address of the apparatus storing the content.

In an example embodiment, the sending of the message may further include: translating the message from a first protocol to a second protocol using a protocol convertor, wherein the first or second protocol may include a SIP protocol.

An example embodiment may include a method and a service resource broker using the method and configured to receive from the apparatus using a control plane different from the media plane, a first message including a content identifier indicating that the content associated with the content identifier is stored in the apparatus and an identifier of the apparatus, store at least the content identifier and the identifier of the apparatus, receive from a service controller, a query including a further content identifier, determine, based on the stored content identifier and the content identifier received in the query, whether the apparatus has a requested content stored, and in response to a determined results, send to the service controller the identifier of the apparatus storing the content.

An example embodiment may include a method and a service controller using the method and configured to, receive, routed from a requestor using a control plane, a message including a content identifier indicating the content to be retrieved, send to the service resource broker a query including the received content identifier, receive from the SRB an apparatus identifier associated with the apparatus storing the content to be retrieved, search for an address of the apparatus based on the apparatus identifier, and send to the apparatus a request to retrieve the content associated with the content identifier.

An example embodiment may include a method and apparatus using the method and configured to receive from a requestor a message destined for the content server redirected via a control plane to the apparatus requesting the content based on a content identifier in the message retrieve and store from the content server the content, and route to the requestor via a media plane the content.

The retrieving of the content may include, sending, by the apparatus to an adapter, a message in a first protocol of the apparatus, converting the first protocol of the apparatus to a second protocol of the content server, and receiving, by the apparatus, the content.

An example embodiment may include a method of managing content retrieval of content stored in a first node of a peer-to-peer P2P network and apparatus using the method and configured to receive from a tracking server a message requesting that the apparatus join the P2P network, as a second node, and indicating that the apparatus retrieve and store the content stored in the first node, join, by the apparatus, the P2P network, as the second node, retrieve and store the content stored in the first node, and send via the P2P network the content to a requesting node that requested the content.

In an example embodiment, the method may further include, querying, by the tracking server, a network peer controller to determine one or more apparatus that are configured to store the content; and determining, by the tracking server, which one of the one or more apparatus to retrieve and store the content of the first node based on at least one of, a signal quality of a wireless communication signal from each of the apparatus, or a communication capability of each apparatus.

An example embodiment may include apparatus for managing content retrieval in a communication network. The apparatus may include a memory configured to store the content as the content traverses the apparatus in a media plane, and transmit/receive unit configured to send to an entity using a control plane different from the media plane, a message including a content identifier indicating that the content associated with the content identifier is stored in the apparatus and receive routed from a requestor via the control plane, a request for the content based on the content identifier.

An example embodiment may include a service resource broker for managing content retrieval of content stored in apparatus in a communication network. The service resource broker may include a transmit/receive unit configured to receive from the apparatus using a control plane different from the media plane, a first message including a content identifier indicating that the content associated with the content identifier is stored in the apparatus and an identifier of the apparatus and receive from a service controller a query including a further content identifier; a memory configured to store at least the content identifier and the identifier of the apparatus; and a processor configured to determine, based on the stored content identifier and the content identifier received in the query, whether the apparatus has a requested content stored such that in response to a determined results, the transmit/receive unit sends to the service controller the identifier of the apparatus storing the content.

An example embodiment may include a service controller for managing content retrieval of content stored in apparatus in a communication network. The service controller may include a transmit/receive unit configured to receive routed from a requestor using a control plane, a message including a content identifier indicating the content to be retrieved; send to a service resource broker (SRB) a query including the received content identifier; and receive from the SRB an apparatus identifier associated with the apparatus storing the content to be retrieved; and a processor configured to search for an address of the apparatus based on the apparatus identifier such that the transmit/receive unit sends to the apparatus a request to retrieve the content associated with the content identifier.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU/UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the exemplary embodiments are not limited to the above-mentioned memories and that other platforms and memories may support the described methods.

Although the invention has been described in terms of an IMS based communication system, it is contemplated that it may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of managing joining to a peer-to-peer (P2P) swarm for content retrieval, the method comprising:
determining whether to invite a content cache server to join the P2P swarm based on a status of the P2P swarm;
upon a determination to invite the content cache server, sending an invite message to request the content cache server to join the P2P swarm; and
placing the content cache server into the P2P swarm.

2. The method of claim 1, wherein the P2P swarm comprises at least one peer node, and the status of the P2P swarm comprises at least one of:
an underlying network condition change;
a peer node joining the P2P swarm;
a peer node leaving the P2P swarm;
a change in traffic condition;
a location of the at least one peer node;
a capability of the at least one peer node; or
a workload of the at least one peer node.

3. The method of claim 1, wherein the P2P swarm comprises at least one peer node, and the status of the P2P swarm comprises at least one of:
available storage or memory space on the at least one peer node;
presence of a content cache server within the vicinity of the at least one peer node;
work load of a content source server;
available bandwidth of the content cache server; or
whether a requested content object has been cached in the content cache server.

4. The method of claim 1, wherein the P2P swarm comprises a plurality of peer nodes, and the status of the P2P swarm comprises at least one of:
a proximity between the peer nodes; or
a quality of a path between the peer nodes.

5. The method of claim 1, wherein the invite message comprises an identifier of requested content and a peer list of peer nodes in the P2P swarm.

6. The method of claim 5, wherein the invite message comprises instruction to retrieve content from a content source server.

7. The method of claim 1, wherein the P2P swarm comprises at least one peer node, the method further comprising:
selecting the content cache server among a plurality of content cache servers based on at least one of:
a quality of a path between each of the content cache server and the at least one peer node;
available storage or memory space on the content cache server;
work load of the content cache server;
available bandwidth of the content cache server;
location of the content cache server; or
whether a requested content object has been cached in the content cache server.

8. The method of claim 1, further comprising:
receiving a response from the content cache server, wherein the content cache server is place into the P2P swarm upon receipt of the response.

9. A peer-to-peer (P2P) tracker application server for managing a peer-to-peer (P2P) swarm for content retrieval, the tracker application server comprising:
a processor configured to:
determine whether to invite a node to join the P2P swarm based on a status of the P2P swarm;
a transmit and receive unit configured to:
send an invite message to request the node to the P2P swarm based on a determination to invite the node to join the P2P swarm; and
storage for storing a peer list associated with the P2P swarm, wherein the processor is configured to place the node into the P2P swarm.

10. The tracker application server of claim 9, wherein the node comprises a content cache server configured to cache content for distribution.

11. The tracker application server of claim 9, wherein the node comprises a network peer deployed and controlled by at least one of a network operator or a service provider.

12. The tracker application server of claim 9, wherein the P2P swarm comprises at least one peer node, and wherein the processor configured to determine whether to invite a node to join the P2P swarm based on at least one of:
an underlying network condition change;
a peer node joining the P2P swarm;
a peer node leaving the P2P swarm;
a change in traffic condition;
a location of the at least one peer node;
a capability of the at least one peer node; or
a workload of the at least one peer node.

13. A method of joining a peer-to-peer (P2P) swarm for content distribution, the method comprising:
receiving an invitation message indicating a request for joining a P2P swarm;
sending a response to the invitation message; and
joining the P2P swarm using a P2P protocol.

14. The method of claim 13, wherein the invitation message comprises an identifier of requested content and a peer list of peer nodes in the P2P swarm.

15. The method of claim 13, wherein the invite message comprises instruction to retrieve content from at least one of a content source server or a peer node.

16. The method of claim 15, further comprising retrieving the content from at least one of the content source server or the peer node based on the instruction.

17. The method of claim 13, further comprising:
determining whether to join the P2P swarm based on at least one of a characteristic of the P2P swarm, a characteristic of a tracker application server, workload, available storage, or content requested.

18. A content cache server for distributing content in a peer-to-peer (P2P) network, the content cache server comprising:
a transmit and receive unit configured to:
receive an invitation message indicating a request for joining a P2P swarm;
send a response to the invitation message;
a processor configured to:
determine whether to join the P2P swarm;
storage for storing cached content for distribution.

19. The content cache server of claim 18, wherein, based on a determination to join the P2P swarm, the processor is configured to join the P2P swarm using a P2P protocol.

20. The content cache server of claim 18, wherein the transmit and receive unit is configured to send a response indicating rejection of the invitation based on a determination not to join the P2P swarm.
